(19) United States
(12) Patent Application Publication
(10) Pub. No.: US 2013/0235274 A1
(43) Pub. Date: Sep. 12, 2013

(54) MOTION VECTOR DETECTION DEVICE, MOTION VECTOR DETECTION METHOD, FRAME INTERPOLATION DEVICE, AND FRAME INTERPOLATION METHOD

(71) Applicants: Osamu Nasu, Tokyo (JP); Yoshiki Ono, Tokyo (JP); Toshiaki Kubo, Tokyo (JP); Naoyuki Fujiyama, Tokyo (JP); Tomoatsu Horibe, Tokyo (JP)

(72) Inventors: Osamu Nasu, Tokyo (JP); Yoshiki Ono, Tokyo (JP); Toshiaki Kubo, Tokyo (JP); Naoyuki Fujiyama, Tokyo (JP); Tomoatsu Horibe, Tokyo (JP)

(73) Assignee: MITSUBISHI ELECTRIC CORPORATION, Tokyo (JP)

(21) Appl. No.: 13/882,851

(22) PCT Filed: Oct. 7, 2011
(86) PCT No.: PCT/JP2011/073188

§ 371 Date: May 1, 2013

(30) Foreign Application Priority Data
Nov. 17, 2010 (JP) 2010-256818

(51) Int. Cl. H04N 5/14

(52) U.S. Cl. CPC H04N 5/145
USPC 348/699

(57) ABSTRACT

A motion vector detection device includes a motion estimator which detects block motion vectors (MV₀) and a motion vector densifier (130). The motion vector densifier (130) further comprises a first motion vector generator (134₁), a second motion vector generator (134₂-134_{N}), and a motion vector corrector (137₁-137_{N}). From each block, the first motion vector generator (134₁) generates sub-blocks on a first layer, and generates a motion vector (MV₁) for each sub-block on the first layer. In each layer from a second layer through an N-th layer, the second motion vector generator (134₂-134_{N}) generates a motion vector (MV₇, where k=2 to N) for each sub-block in the layer. The motion vector corrector (137₁-137_{N}) corrects the motion vectors of the sub-blocks in layers subject to correction among the first through N-th layers.

### TECHNICAL FIELD

The present invention relates to the art of detecting motion vectors on the basis of a series of frames in a video signal.

### BACKGROUND ART

Display devices of the hold type, typified by liquid crystal display (LCD) devices, have the particular problem that moving objects in a moving picture appear blurred to the viewer because the same displayed image is held for a fixed interval (one frame interval, for example) during which it is continuously displayed. The specific cause of the apparent blur is that while the viewer's gaze moves to track the moving object, the object does not move during the intervals in which it is held, creating a difference between the actual position of the object and the viewer's gaze. A known means of alleviating this type of motion blur is frame interpolation, which increases the number of frames displayed per unit time by inserting interpolated frames into the frame sequence. Another technique is to generate high-resolution frames from a plurality of low-resolution frames and then generate the interpolated frames from the high-resolution frames to provide a higher-definition picture.

In these frame interpolation techniques it is necessary to estimate the pixel correspondence between the frames, that is, to estimate the motion of objects between frames. The block matching method, in which each frame is divided into a plurality of blocks and the motion of each block is estimated, is widely used as a method of estimating the motion of objects between frames. The block matching method generally divides one of two temporally consecutive frames into blocks, takes each of these blocks in turn as the block of interest, and searches for a reference block in the other frame that is most highly correlated with the block of interest. The difference in position between the most highly correlated reference block and the block of interest is detected as a motion vector. The most highly correlated reference block can be found by, for example, calculating the absolute values of the brightness differences between pixels in the block of interest and a reference block, taking the sum of the calculated absolute values, and finding the reference block with the smallest such sum.

A problem with the conventional block matching method is that since each block has a size of, say, 8×8 pixels or 16×16 pixels, image defects occur at the block boundaries in the interpolated frames generated using the motion vectors found by the block matching method, and the picture quality is reduced. This problem could be solved if it were possible to detect motion vectors accurately on a pixel basis (with a precision of one pixel). The problem is that it is difficult to improve the accuracy of motion vector estimation on a pixel basis. The motion vector detected for each block can be used as the motion vector of each pixel in the block, for example, but then all pixels in the block show the same motion, so the motion vectors of the individual pixels have not been detected accurately. It is also known that reducing the size of the blocks used to estimate detect motion vectors on a pixel basis does not improve the accuracy of motion vector estimation. A further problem is that reducing the block size greatly increases the amount of computation.

Techniques for generating motion vectors on a pixel basis from block motion vectors are disclosed in Japanese Patent No. 4419062 (Patent Reference 1), Japanese Patent No. 4374048 (Patent Reference 2), and Japanese Patent Application Publication No. H11-177940 (Patent Reference 3). The methods disclosed in Patent References 1 and 3 take, as candidates, the motion vector of the block including the pixel of interest (the block of interest) in one of two temporally distinct frames and the motion vectors of blocks adjacent the block of interest, and find the difference in pixel value between the pixel of interest and the pixels in positions in the other frame shifted per the candidate motion vectors from the position of the pixel of interest. From among the candidate motion vectors, the motion vector with the smallest difference is selected as the motion vector of the pixel of interest (as its pixel motion vector). The method disclosed in Patent Reference 2 seeks further improvement in detection accuracy by, when pixel motion vectors have already been determined, adding the most often used pixel motion vector as an additional candidate motion vector.

### PRIOR ART REFERENCES

### Patent References

Patent Reference 1: Japanese Patent No. 4419062 (FIGS. 5-12, paragraphs 0057-0093 etc.)
Patent Reference 2: Japanese Patent No. 4374048 (FIGS. 3-6, paragraphs 0019-0040 etc.)
Patent Reference 3: Japanese Patent Application Publication No. H11-177940 (FIGS. 1 and 18, paragraphs 0025-0039 etc.)

### SUMMARY OF THE INVENTION

### Problems to be Solved by the Invention

As described above, the methods in Patent References 1 to 3 select the motion vector of the pixel of interest from among candidate block motion vectors. However, there is a problem in that if there are periodic spatial patterns (repetitive patterns such as stripe patterns with high spatial frequencies) and noise in the image, this interferes with the selection of accurate motion vectors with high estimation accuracy.

In view of the above, an object of the present invention is to provide a motion vector detection device, motion vector detection method, frame interpolation device, and frame interpolation method that can restrict the lowering of pixel motion vector estimation accuracy due to the effects of periodic spatial patterns and noise appearing in the image.

### Means of Solving the Problems

A motion vector detection device according to a first aspect of the invention detects motion in a series of frames constituting a moving image. The motion vector detection device includes: a motion estimator for dividing a frame of interest in the series of frames into a plurality of blocks, and for, taking a frame temporally differing from the frame of interest in the series of frames as a reference frame, estimating motion of each of the blocks between the frame of interest and the reference frame, thereby detecting block motion vectors; and a motion vector densifier for, based on the plurality of blocks, generating a plurality of sub-blocks on a plurality of layers including a first layer to an N-th layer (N being an integer equal to or greater than 2) and generating a motion vector for each one of the sub-blocks, based on the block motion vectors. The motion vector densifier includes: a first motion vector generator for taking each block in the plurality of blocks as a parent block, generating a plurality of sub-blocks on the first layer from the parent block, and generating a motion vector for each of the plurality of sub-blocks on the first layer, based on the block motion vectors; a second motion vector generator for generating, in the plurality of layers from the first to the N-th layer, a plurality of sub-blocks on each layer from the second to the N-th layer based on parent sub-blocks, the parent sub-blocks being the sub-blocks on a higher layer which is at one level higher than each layer, and for generating a motion vector for each of the plurality of sub-blocks on each of the layers from the second to the N-th layer, based on the motion vectors of the sub-blocks on the higher layer; and a motion vector corrector for, on at least one layer to be corrected among the first to the N-th layers, taking each of the plurality of sub-blocks on the layer to be corrected as a sub-block to be corrected, and correcting the motion vector of the sub-block to be corrected so as to minimize a sum of distances between the motion vector of the sub-block to be corrected and motion vectors belonging to a set including the motion vector of the sub-block to be corrected and motion vectors of neighboring sub-blocks located in an area surrounding the sub-block to be corrected. The second motion vector generator uses the motion vectors as corrected by the motion vector corrector to generate the motion vector of each of the plurality of sub-blocks in the layer following the layer to be corrected.

A frame interpolation device according to a second aspect of the invention includes the motion vector detection device according to the first aspect and an interpolator for generating an interpolated frame on a basis of the sub-block motion vectors detected by the motion vector detection device.

A motion vector detection method according to a third aspect of the invention detects motion in a series of frames constituting a moving image. The motion vector detection method includes: a motion estimation step of dividing a frame of interest in the series of frames into a plurality of blocks, taking a frame temporally differing from the frame of interest in the series of frames as a reference frame, and estimating motion of each of the blocks between the frame of interest and the reference frame, thereby detecting block motion vectors; and a motion vector densifying step of generating a plurality of sub-blocks on a plurality of layers including a first layer to an N-th layer (N being an integer equal to or greater than 2) and generating a motion vector for each one of the sub-blocks, based on the block motion vectors. The motion vector densifying step includes: a first motion vector generation step of taking each block in the plurality of blocks as a parent block, generating a plurality of sub-blocks on the first layer from the parent block, and generating a motion vector for each of the plurality of sub-blocks on the first layer, based on the block motion vectors; a second motion vector generation step of generating, in the plurality of layers from the first to the N-th layer, a plurality of sub-blocks on each layer from the second to the N-th layer based on parent sub-blocks, the parent sub-blocks being the sub-blocks on a higher layer which is at one level higher than each layer, and for generating a motion vector for each of the plurality of sub-blocks on each of the layers from the second to the N-th layer, based on the motion vectors of the sub-blocks on the higher layer; and a correction step of, on at least one layer to be corrected among the first to the N-th layers, taking each of the plurality of sub-blocks on the layer to be corrected as a sub-block to be corrected, and correcting the motion vector of the sub-block to be corrected so as to minimize a sum of distances between the motion vector of the sub-block to be corrected and motion vectors belonging to a set including the motion vector of the sub-block to be corrected and motion vectors of neighboring sub-blocks located in an area surrounding the sub-block to be corrected. The second motion vector generation step uses the corrected motion vectors to generate the motion vector of each of the plurality of sub-blocks in the layer following the layer to be corrected.

A frame interpolation method according to a fourth aspect of the invention includes the motion estimation step and the motion vector densifying step of the motion vector detection method according to the third aspect, and a step of generating an interpolated frame on a basis of the sub-block motion vectors detected in the motion vector densifying step.

### Effect of the Invention

According to the present invention, the lowering of pixel motion vector estimation accuracy due to the effects of periodic spatial patterns and noise appearing in the image can be restricted.

### BRIEF DESCRIPTION OF THE DRAWINGS

FIG. 1 is a block diagram schematically illustrating the structure of the motion vector detection device in a first embodiment of the present invention.

FIG. 2 is a drawing schematically illustrating an exemplary location on the temporal axis of a pair of frames used for motion estimation according to the first embodiment.

FIG. 3 is a drawing conceptually illustrating exemplary first to third layers of sub-blocks in a hierarchical subdivision according to the first embodiment.

FIG. 4 is a functional block diagram schematically illustrating the structure of the motion vector densifier in the first embodiment.

FIG. 5 is a functional block diagram schematically illustrating the structure of a motion vector generator in the first embodiment.

FIG. 6 is a flowchart schematically illustrating the candidate vector extraction procedure performed by a candidate vector extractor in the first embodiment.

FIGS. 7(A) and 7(B) are drawings showing an example of candidate vector extraction according to the first embodiment.

FIG. 8 is a drawing showing another example of candidate vector extraction according to the first embodiment.

FIGS. 9(A) and 9(B) are drawings showing a further example of candidate vector extraction according to the first embodiment.

FIG. 10 is a drawing schematically illustrating exemplary locations on the temporal axis of a pair of frames used to select a candidate vector according to the first embodiment.

FIGS. 11(A) and 11(B) are diagrams showing an example of the motion vector correction method according to the first embodiment.

FIG. 12 is a flowchart schematically illustrating a procedure for the motion vector correction process performed by the hierarchical processing section according to the first embodiment.

FIG. 13 is a block diagram schematically illustrating the structure of the motion vector detection device in a second embodiment of the invention.

FIG. 14 is a drawing schematically illustrating exemplary locations on the temporal axis of three frames used for motion estimation according to the second embodiment.

FIG. 15 is a block diagram schematically illustrating the structure of the motion vector detection device in a third embodiment according to the invention.

FIG. 16 is a drawing schematically illustrating locations on the temporal axis of a pair of frames used for motion estimation in the third embodiment.

FIG. 17 is functional block diagram schematically illustrating the structure of the motion vector densifier in the third embodiment.

FIG. 18 is a functional block diagram schematically illustrating the structure of the motion vector generator in the third embodiment.

FIG. 19 is a drawing showing a moving object appearing on a sub-block image on the k-th layer.

FIG. 20 is a functional block diagram schematically illustrating the structure of the motion vector detection device in a fourth embodiment according to the invention.

FIG. 21 is a functional block diagram schematically illustrating the structure of the motion vector densifiers in the motion vector detection device in a fifth embodiment according to the invention.

FIG. 22 is a functional block diagram schematically illustrating the structure of a motion vector generator in the fifth embodiment.

FIG. 23 is a flowchart schematically illustrating a procedure for the candidate vector extraction process performed by the candidate vector extractor in the fifth embodiment.

FIG. 24 is a block diagram schematically illustrating the structure of the frame interpolation device in the fifth embodiment according to the invention.

FIG. 25 is a drawing illustrating a linear interpolation method as an exemplary frame interpolation method.

FIG. 26 is a drawing schematically illustrating an exemplary hardware configuration of a frame interpolation device.

### MODE FOR CARRYING OUT THE INVENTION

Embodiments of the invention will now be described with reference to the attached drawings.

### First Embodiment

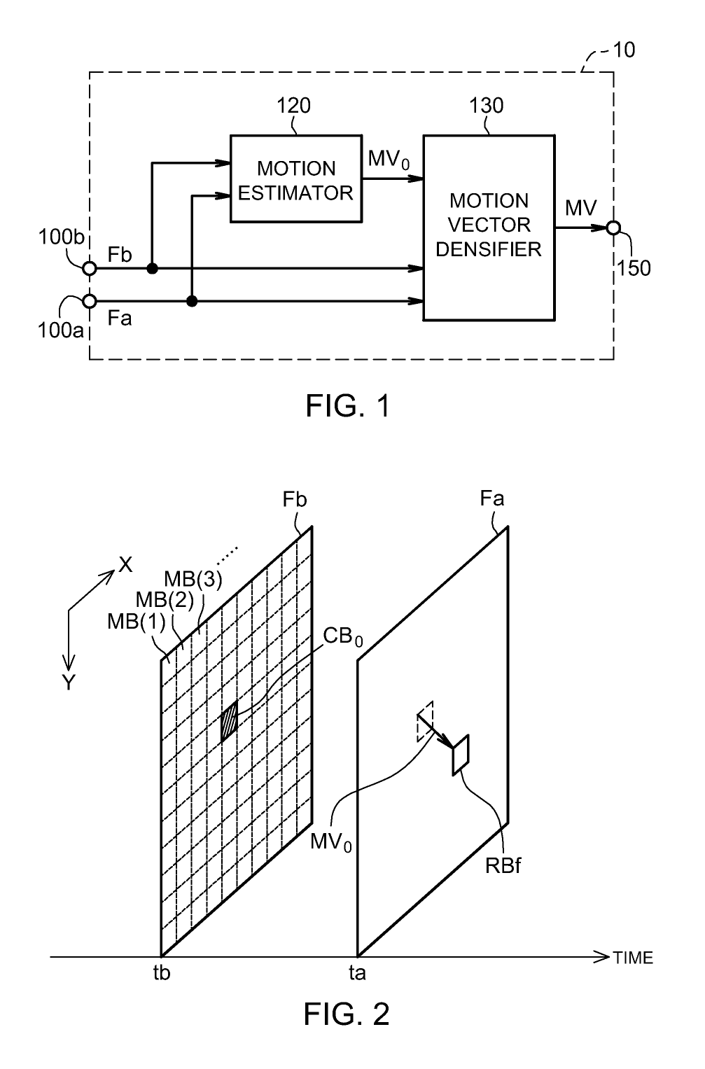

FIG. 1 is a block diagram schematically illustrating the structure of the motion vector detection device 10 in a first embodiment of the invention. The motion vector detection device 10 has input units 100a, 100b, to which temporally distinct first and second frames Fa, Fb are input, respectively, from among a series of frames forming a moving image. The motion vector detection device 10 also has a motion estimator 120 that detects block motion vectors MV₀ from the input first and second frames Fa and Fb, and a motion vector densifier 130 that generates pixel motion vectors MV (with one-pixel precision) based on the block motion vectors MV₀. Motion vectors MV are externally output from an output unit 150.

FIG. 2 is a drawing schematically illustrating exemplary locations of the first frame Fa and second frame Fb on the temporal axis. The first frame Fa and second frame Fb are respectively assigned times to and tb, which are identified by timestamp information. In this embodiment, the motion vector detection device 10 uses the second frame as the frame of interest and the first frame, which is input temporally following the second frame, as a reference frame, but this is not a limitation. It is also possible to use the first frame Fa as the frame of interest and the second frame Fb as the reference frame.

As schematically shown in FIG. 2, the motion estimator 120 divides the frame of interest Fb into multiple blocks (of, for example, 8×8 pixels or 16×16 pixels) MB(1), MB(2), MB(3), . . . , takes each of these blocks, MB(1), MB(2), MB(3), . . . in turn as the block of interest CB₀, and estimates the motion of the block of interest CB₀, from the frame of interest Fb to the reference frame Fa. Specifically, the motion estimator 120 searches for a reference block RBf in the reference frame Fa that is most highly correlated with the block of interest CB₀ in the frame of interest Fb, and detects the displacement in the spatial direction (a direction determined by the horizontal pixel direction X and vertical pixel direction Y) between the block of interest CB₀ and the reference block RBf as the motion vector of the block of interest CB₀. The motion estimator 120 thereby detects the motion vectors MV₀(1), MV₀(2), MV₀(3), . . . of MB(1), MB(2), MB(3), . . . , respectively.

As the method of detecting motion vectors MV₀(1), MV₀(2), MV₀(3), . . . , (motion vectors MV₀), the known block matching method may be used. With the block matching method, in order to evaluate the degree of correlation between a reference block RBf and the block of interest CB₀, an evaluation value based on the similarity or dissimilarity between these two blocks is determined. Various methods of calculating the evaluation value have been proposed. In one method that can be used, the absolute values of the block-to-block differences in the brightness values of individual pixels are calculated and summed to obtain a SAD (Sum of Absolute Difference), which is used as the evaluation value. The smaller the SAD becomes, the greater the similarity between the blocks to be compared becomes (in other words, the dissimilarity becomes less).

Ideally, the range searched to find the reference block RBf covers the entire reference frame Fa, but since it requires a huge amount of computation to calculate the evaluation value for all locations, it is preferable to search in a restricted range centered on the position corresponding to the position of the block of interest CB₀ in the frame.

This embodiment uses the block matching method as a preferred but non-limiting method of detecting motion vectors; that is, it is possible to use an appropriate method other than the block matching method. For example, instead of the block matching method, the motion estimator 120 may use a known gradient method (e.g., the Lucas-Kanade method) to generate block motion vectors MV₀ at high speed.

The motion vector densifier 130 hierarchically subdivides each of the blocks MB(1), MB(2), MB(3), . . . , thereby generating first to N-th layers of sub-blocks (N being an integer equal to or greater than 2). The motion vector densifier 130 also has the function of generating a motion vector for each sub-block on each layer.

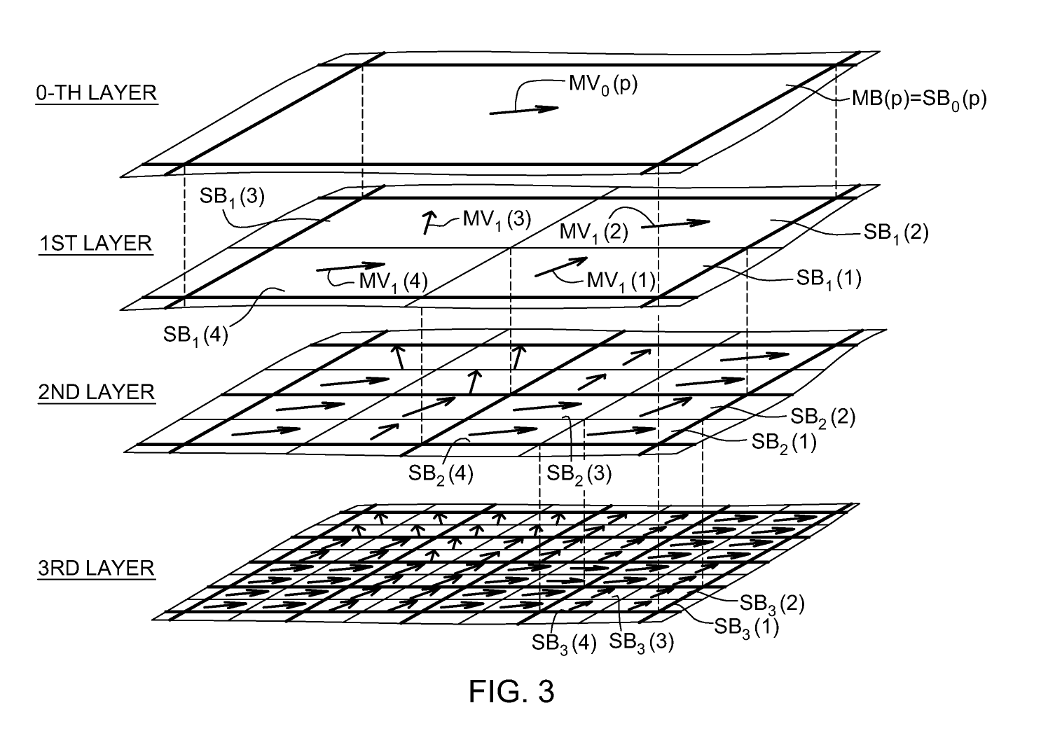

FIG. 3 is a drawing schematically illustrating sub-blocks SB₁(1), SB₁(2), . . . , SB₂(1), SB₂(2), . . . , SB₃(1), SB₃(2), . . . assigned to a first layer to a third layer. As shown in FIG. 3, the four sub-blocks, SB₁(1), SB₁(2), SB₁(3), SB₁(4) are obtained by dividing a block MB(p) (p being a positive integer) on the higher layer (the 0-th layer) which is at one level higher than the first layer, into quarters with a reduction ratio of 1/2 in the horizontal pixel direction X and vertical pixel direction Y. The motion vectors MV₁(1), MV₁(2), MV₁(3), MV₁(4), . . . of the sub-blocks SB₁(1), SB₁(2), SB₁(3), SB₁(4), . . . on the first layer are determined from the motion vectors of the blocks on the 0-th layer. The sub-blocks SB₂(1), SB₂(2), SB₂(3), SB₂(4), . . . on the second layer are obtained by dividing the individual sub-blocks SB₁(1), SB₁(2), . . . into quarters with a reduction ratio of 1/2. The motion vectors of the sub-blocks SB₂(1), SB₂(2), SB₂(3), SB₂(4), . . . on the second layer are determined from the motion vectors of the sub-blocks on the first layer which is at one level higher than the second layer. The sub-blocks SB₃(1), SB₃(2), SB₃(3), SB₃(4), . . . on the third layer are obtained by dividing the individual sub-blocks SB₂(1), SB₂(2), . . . into quarters with a reduction ratio of 1/2. The motion vectors of these sub-blocks SB₃(1), SB₃(2), SB₃(3), SB₃(4), . . . are determined from the motion vectors of the sub-blocks on the second layer which is at one level higher than the third layer. As described above, the function of the motion vector densifier 130 is to generate sub-blocks SB₁(1), SB₂(1), SB₂(2), . . . , SB₃(1), SB₃(2), . . . on the first to third layers by recursively dividing each block on the 0-th layer, and generate successively higher-density motion vectors from the low-density motion vectors on the 0-th layer (density being the number of motion vectors per unit number of pixels).

In the example in FIG. 3, the reduction ratios used for the subdivision of block MB(p) and the sub-blocks SB₁(1), SB₁(2), . . . , SB₂(1), SB₂(2), . . . are all 1/2, but this is not a limitation. A separate reduction ratio may be set for each stage of the subdivision process.

Depending on the size and reduction ratio of a sub-block, in some cases the size (the number of horizontal pixels and the number of vertical pixels) does not take an integer value. In such cases, the digits after the decimal point may be rounded down or rounded up. In some cases, sub-blocks generated by subdivision of different parent blocks (or sub-blocks) may overlap in the same frame. Such cases can be dealt with by selecting one of the parent blocks (or sub-blocks) and selecting the sub-blocks generated from the selected parent.

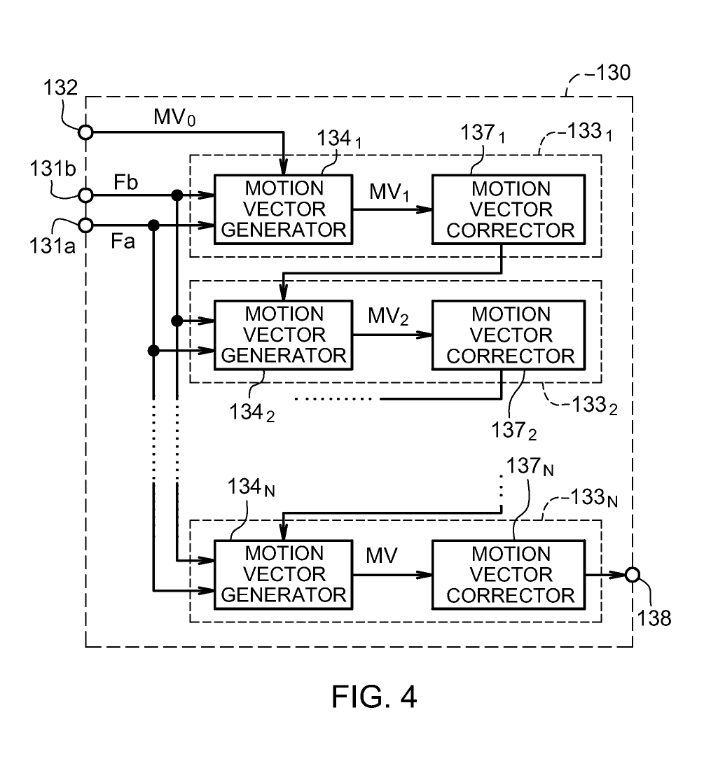

FIG. 4 is a functional block diagram schematically illustrating the structure of the motion vector densifier 130. As shown in FIG. 4, the motion vector densifier 130 has an input unit 132 to which a block motion vector MV₀ is input, input units 131a and 131b to which the reference frame Fa and the frame of interest Fb are input, first to N-th hierarchical processing sections 133₁ to 133_{N} (N being an integer equal to or greater than 2), and an output unit 138 for output of pixel motion vectors MV. Each hierarchical processing section 133ₖ has a motion vector generator 134ₖ and a motion vector corrector 137ₖ (k being an integer from 1 to N).

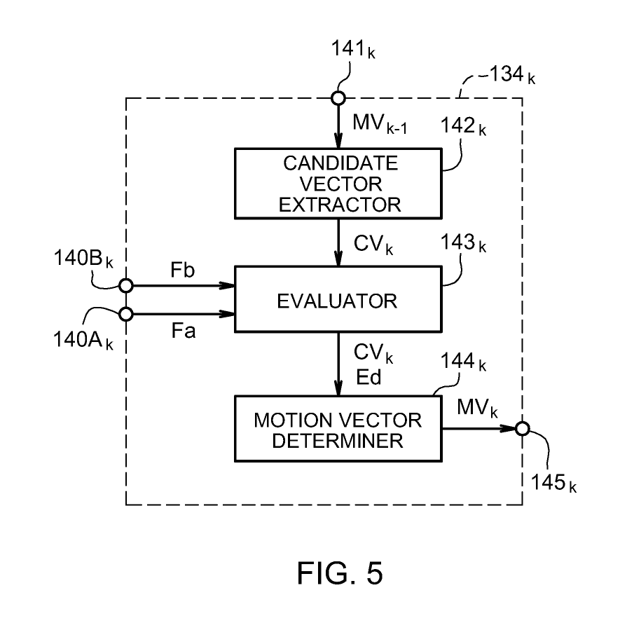

FIG. 5 is a functional block diagram schematically illustrating the structure of the motion vector generator 134ₖ. As shown in FIG. 5, the motion vector generator 134ₖ has an input unit 141ₖ that receives the motion vector MVₖ₌₁ input from the previous stage, input units 140Aₖ, 140Bₖ, a candidate vector extractor 142ₖ, an evaluator 143ₖ, and a motion vector determiner 144ₖ.

The basic operations of the hierarchical processing sections 133₁ to 133_{N} are all the same. The process in the hierarchical processing section 133ₖ will now be described in detail, using the blocks MB(1), MB(2), . . . processed in the first hierarchical processing section 133₁ as 0-th layer sub-blocks SB₀(1), SB₀(2), . . . .

In the motion vector generator 134ₖ, the candidate vector extractor 142ₖ takes sub-blocks SBₖ(1), SBₖ(2), SBₖ(3), . . . one by one in turn as the sub-block of interest CBₖ, and extracts at least one candidate vector CVₖ from the set of motion vectors of the sub-blocks SBₖ₌₁(1), SBₖ₌₁(2) SBₖ₌₁(3), . . . , on the higher layer which is at one level higher than the k-th layer for the sub-block of interest CVₖ. The extracted candidate vector CVₖ is sent to the evaluator 143ₖ.

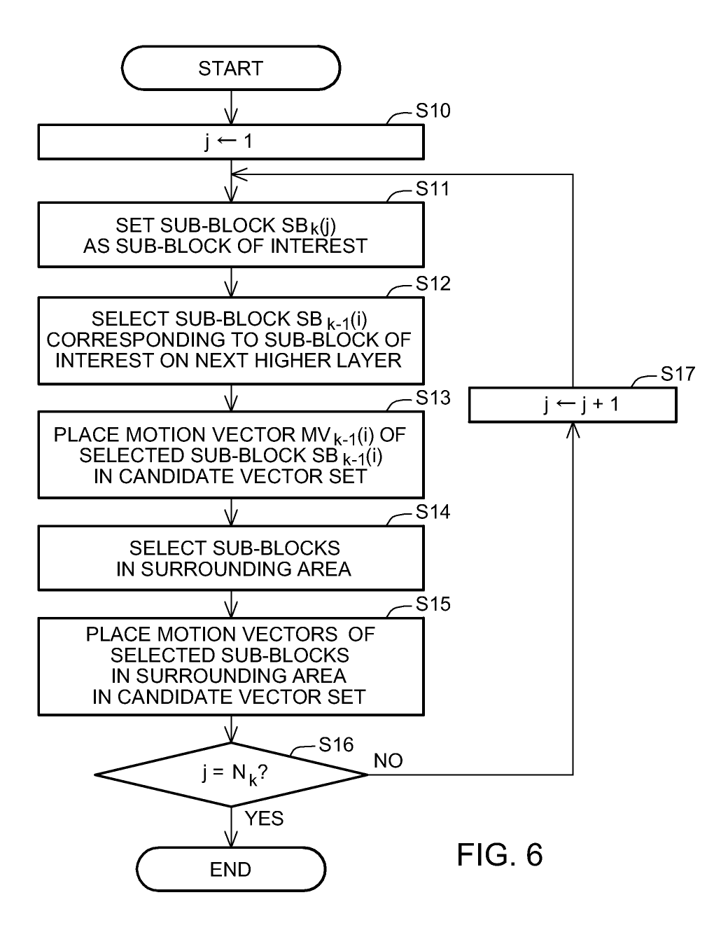

FIG. 6 is a flowchart schematically illustrating the procedure followed in the candidate vector extraction process executed by the candidate vector extractor 142ₖ. As shown in FIG. 6, the candidate vector extractor 142ₖ first initializes the sub-block number j to ‘1’ (step S10), and sets the j-th sub-block SBₖ(j) as the sub-block of interest CBₖ (step S11). Then the candidate vector extractor 142ₖ selects the sub-block SBₖ₌₁(i) that is the parent of the sub-block of interest CBₖ from among the sub-blocks on the higher layer, i.e., the (k=1)-th layer which is at one level higher than the current layer (step S12), and places the motion vector MVₖ₌₁(i) of this sub-block SBₖ₌₁(i) in a candidate vector set Vₖ(j) (step S13).

After that, the candidate vector extractor 142ₖ selects a group of sub-blocks in an area surrounding the parent sub-block SBₖ₌₁(i) on the (k=1)-th layer (step S14), and places the motion vectors of the sub-blocks in this group in the candidate vector set Vₖ(j) (step S15).

Next, the candidate vector extractor 142ₖ determines whether or not the sub-block number j has reached the total number Nₖ of sub-blocks belonging to the k-th layer (step S16). If the sub-block number j has not reached the total number Nₖ (No in step S16), the sub-block number j is incremented by 1 (step S17) and the process returns to step S11. When the sub-block number j reaches the total number Nₖ (Yes in step S16), the candidate vector extraction process ends.

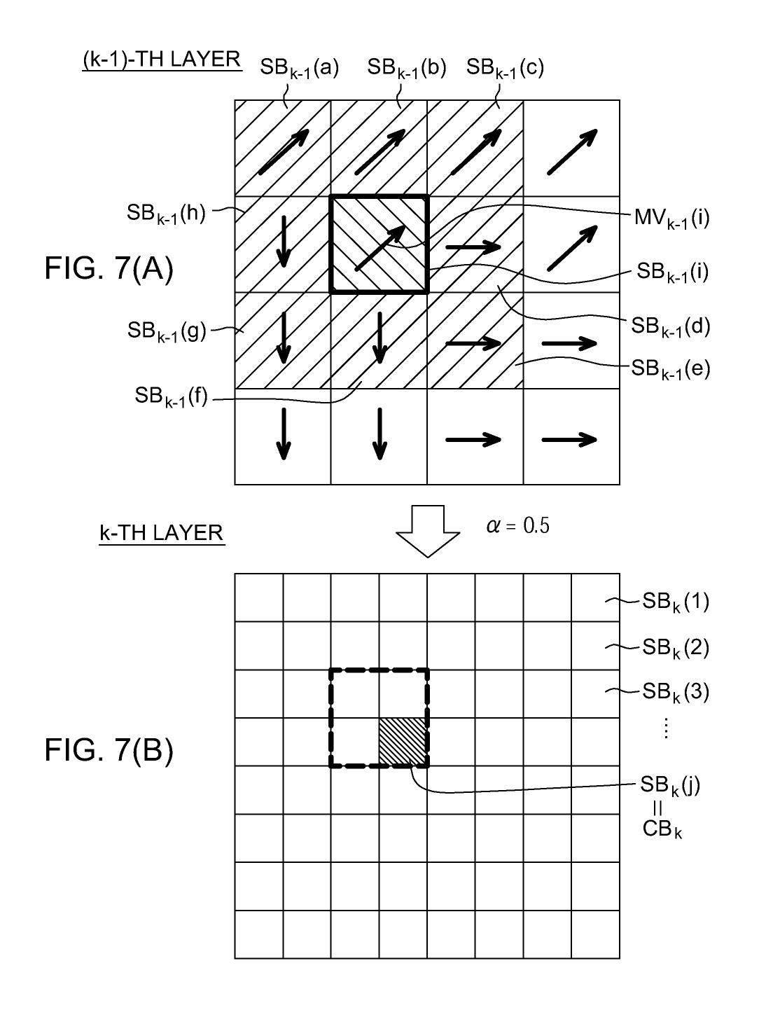

FIGS. 7(A) and 7(B) are drawings illustrating an exemplary procedure followed in the candidate vector extraction process. The sub-blocks SBₖ(1), SBₖ(2), SBₖ(3), . . . , on the k-th layer shown in FIG. 7(B) have been generated by division of each sub-block on the (k=1)-th layer shown in FIG. 7(A) with a reduction ratio α=1/2 (=0.5). When sub-block SBₖ(j) is used as the sub-block of interest CBₖ, sub-block SBₖ₌₁(i) is selected as the corresponding parent from which the sub-block of interest CBₖ was generated (step S12). Next, the motion vector MVₖ₌₁(i) of sub-block SBₖ₌₁(i) is placed in the candidate vector set Vₖ(j) (step S13). The eight sub-blocks SBₖ₌₁(a) to SBₖ₌₁(h) in the area surrounding the parent sub-block SBₖ₌₁(i), respectively adjacent to it in eight directions, these being the horizontal pixel directions, vertical pixel directions, diagonally upward right direction, diagonally downward right direction, diagonally upward left direction, and diagonally downward left direction, are also selected (step S14). Next, the motion vectors of sub-blocks SBₖ₌₁(a) to SBₖ₌₁(h) are placed in the candidate vector set Vₖ(j) (step S15). Consequently, the nine motion vectors of nine sub-blocks SBₖ₌₁(i) and SBₖ₌₁(a) to SBₖ₌₁(h) on the (k=1)-th layer are extracted as candidate vectors and placed in the candidate vector set Vₖ(j).

Not all of the sub-blocks SBₖ₌₁(a) to SBₖ₌₁(h) neighboring the parent sub-block SBₖ₌₁(i) need be selected in step S14. Furthermore, this embodiment is also workable in cases in which sub-blocks surrounding but not adjacent to sub-block SBₖ₌₁(i) are selected or cases in which a sub-block is selected from another frame temporally adjacent to the frame Fb to which the parent sub-block SBₖ₌₁(i) belongs (e.g., a sub-block at a position corresponding to the position of sub-block SBₖ₌₁(i) in the other frame).

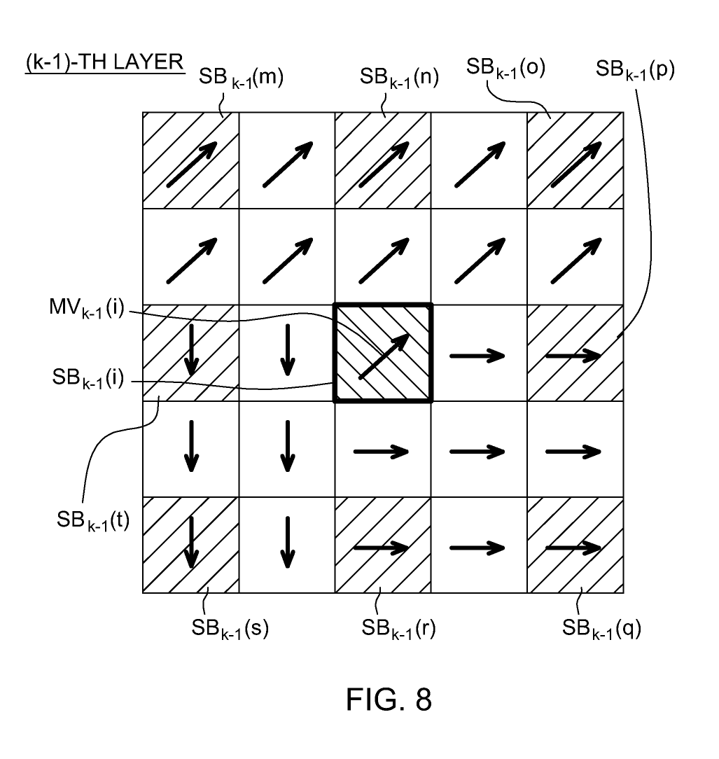

In step S14, sub-blocks may also be selected from an area other than the area adjacent in eight directions to the parent sub-block SBₖ₌₁(i). For example, as shown in FIG. 8, sub-blocks may be selected from the eight sub-blocks SBₖ₌₁(m) to SBₖ₌₁(t) two sub-blocks away from the parent sub-block SBₖ₌₁(i) in eight directions. If the sub-blocks are not limited to adjacent sub-blocks but more distant sub-blocks are selected in this way, then even if multiple sub-blocks having mistakenly detected motion vectors are localized (when a plurality of such sub-blocks are clustered in a group), correct motion vectors can be added to the candidate vector set instead of the mistakenly detected motion vectors.

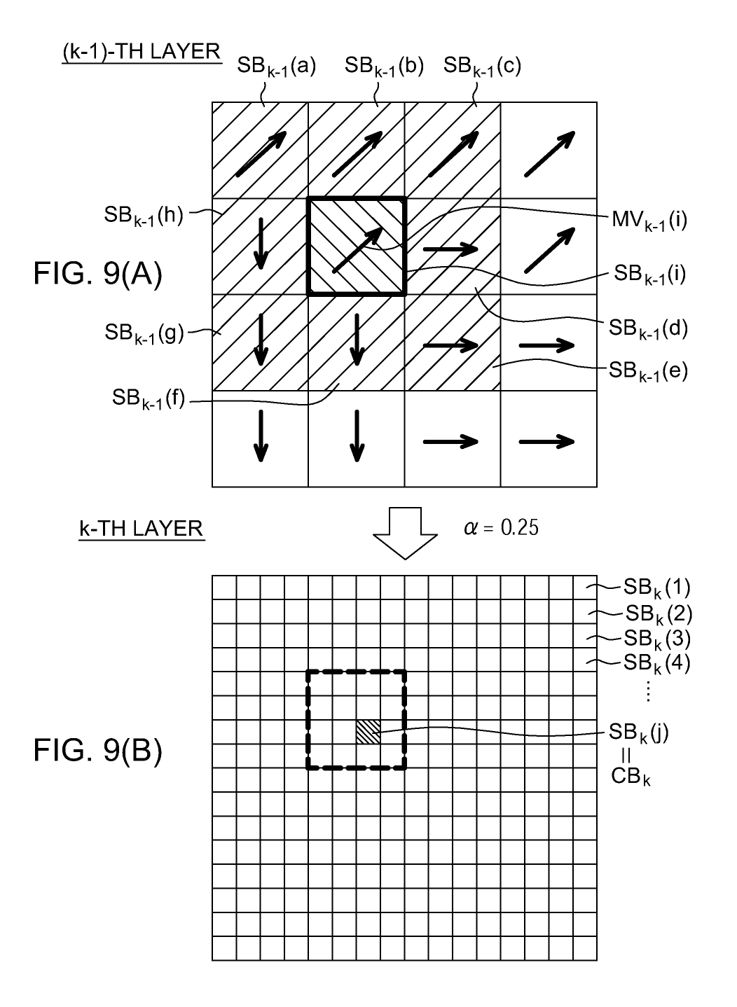

Furthermore, the reduction ratio α is not limited to 1/2. FIGS. 9(A) and 9(B) are drawings showing another exemplary procedure that can be followed in the candidate vector extraction process. Each sub-block on the k-th layer shown in FIG. 9(A) is divided with a reduction ratio α=1/4 (=0.25), generating sub-blocks SBₖ(1), SBₖ(2), SBₖ(3), SBₖ(4), . . . on the k-th layer as shown in FIG. 9(B). If sub-block SBₖ(j) in FIG. 9(B) is set as the sub-block of interest CBₖ, the parent sub-block SBₖ₌₁(i) corresponding to the sub-block of interest CBₖ is selected (step S12). Next, the motion vector MV₌₁(i) of sub-block SBₖ₌₁(i) is placed in the candidate vector set Vₖ(j) (step S13). Sub-blocks may then be selected from among the neighboring sub-blocks SBₖ₌₁(a) to SBₖ₌₁(h) surrounding the parent sub-block SBₖ₌₁(i) (step S14), and the motion vectors of the selected sub-blocks may be placed in the candidate vector set Vₖ(j) (step S15). In step S14, it is also possible to select the sub-blocks SBₖ₌₁(c) to SBₖ₌₁(g) in the two lines spatially nearest the sub-block of interest CBₖ from among the four lines of sub-blocks bounding the parent sub-block SBₖ₌₁(i).

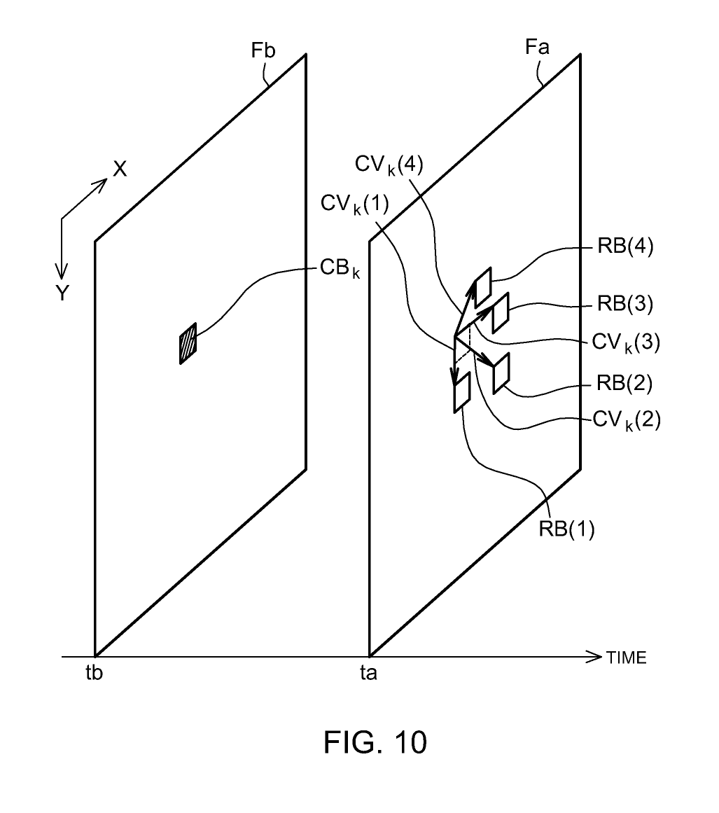

After the candidate vector is selected as described above, the evaluator 143ₖ extracts reference sub-blocks RB with coordinates (Xr+CVx, Yr+CVy) at positions shifted from the position (Xr, Yr) in the reference frame Fa corresponding to the position pos=(Xc, Yc) of the sub-block of interest CBₖ by the candidate vectors CVₖ. Here, CVx and CVy are the horizontal pixel direction component (X component) and vertical pixel direction component (Y component) of the candidate vectors CVₖ, and the size of the reference sub-block RB is identical to the size of the sub-block of interest CBₖ. For example, as shown in FIG. 10, when four candidate vectors CVₖ(1) to CVₖ(4) are extracted for the sub-block of interest CBₖ in the frame of interest Fb, the four reference sub-blocks RB(1) to RB(4) indicated by these candidate vectors CVₖ(1) to CVₖ(4) can be extracted.

In addition, the evaluator 143ₖ calculates the similarity or dissimilarity of each pair of sub-blocks consisting of an extracted reference sub-block RB and the sub-block of interest CBₖ, and based on the calculation result, it determines the evaluation value Ed of the candidate vector. For example, the sum of absolute differences (SAD) between the pair of blocks may be calculated as the evaluation value Ed. In the example in FIG. 10, since four block pairs are formed between the sub-block of interest CBₖ and the four reference sub-blocks RB(1) to RB(4), the evaluator 143ₖ calculates evaluation values of the candidate vectors for each of these block pairs. These evaluation values Ed are sent to the motion vector determiner 144ₖ together with their paired candidate vectors CVₖ.

On the basis of the evaluation values, the motion vector determiner 144ₖ now selects the most likely motion vector from the candidate vector set Vₖ(j) as the motion vector MVₖ of the sub-block of interest CBₖ (=SBₖ(j)). The motion vector MVₖ is output to the next stage via the output unit 145ₖ.

The motion vector determiner 144ₖ can select the motion vector by using the following expression (1).

$$\begin{matrix}[ Expression 1 ] & \\ \{ \begin{matrix}{v}_{t} = argmin ( SAD ( {v}_{i} ) ) \\ {v}_{i} ∈ {V}_{k} \\ SAD ( {v}_{i} ) = {\sum }_{pos ∈ B} \vert {f}_{b} ( pos ) - {f}_{a} ( pos + {v}_{i} ) \vert\end{matrix} & ( 1 )\end{matrix}$$

Here, vᵢ is a candidate vector belonging to the candidate vector set Vₖ; fₐ(x) is the value of a pixel in the reference frame Fa indicated by a position vector x; f_{b}(x) is the value of a pixel in the frame of interest Fb indicated by a position vector x; B is a set of position vectors indicating positions in the sub-block of interest; pos is a position vector belonging to set B. SAD(vᵢ) is a function that outputs the sum of the absolute differences between a pair of sub-blocks, namely a reference sub-block and the sub-block of interest; arg min (SAD(vᵢ)) gives the vᵢ (=vₜ) that minimizes SAD(vᵢ).

In this way, the motion vector MVₖ(=vₜ) most likely to represent the true motion can be selected on the basis of the SAD. Alternatively, the evaluation value Ed may be calculated by using a definition differing from the SAD definition.

Next the motion vector corrector 137ₖ in FIG. 4 will be described.

The motion vector corrector 137ₖ has a filtering function that takes each of the sub-blocks SBₖ(1), . . . , SBₖ(Nₖ) on the k-th layer in turn as the sub-block of interest and corrects its motion vector on the basis of the motion vectors of the neighboring sub-blocks located in the area surrounding the sub-block of interest. When an erroneous motion vector MVₖ is output from the motion vector generator 134ₖ, this filtering function can prevent the erroneous motion vector MVₖ from being transmitted to the hierarchical processing section 133ₖ₊₁ in the next stage, or to the output unit 138.

When the motion vector of the sub-block of interest clearly differs from the motion vectors of the sub-blocks in its surrounding area, use of a smoothing filter could be considered in order to eliminate the anomalous motion vector and smooth the distribution of sub-block motion vectors. However, the use of a smoothing filter might produce a motion vector representing non-existent motion.

If the motion vector of the sub-block of interest is erroneously detected as (9, 9) and the motion vectors of the eight sub-blocks neighboring the sub-block of interest are all (0, 0), for example, a simple smoothing filter (an averaging filter which takes the arithmetic average of multiple motion vectors) with an application range (filter window) of 3 sub-blocks×3 sub-blocks would output the vector (1, 1) for the sub-block of interest. This output differs from the more likely value (0, 0), and represents non-existent motion. In frame interpolation and super-resolution, it is preferable to avoid output of vectors not present in the surrounding area.

The motion vector corrector 137ₖ in this embodiment therefore has a filtering function that sets the motion vector of the sub-block of interest (sub-block to be corrected) and the motion vectors of the sub-blocks in the application range (filter window), including sub-blocks surrounding the sub-block of interest, as correction candidate vectors v_{c}, selects a correction candidate vector v_{c} with a minimum sum of distances from the motion vectors of the surrounding sub-blocks and the motion vector of the sub-block of interest, and replaces the motion vector of the sub-block of interest with the selected correction candidate vector. Various mathematical concepts of the distance between two motion vectors are known, such as Euclidean distance, Manhattan distance, Chebyshev distance, etc.

This embodiment employs Manhattan distance as the distance between the motion vectors of the surrounding sub-blocks and the motion vector of the sub-block of interest. With Manhattan distance, the following expression (2) can be used to generate a new motion vector vₙ of the sub-block of interest.

$$\begin{matrix}[ Expression 2 ] & \\ \{ \begin{matrix}{v}_{n} = arg min ( dif ( {v}_{c} ) ) \\ dif ( {v}_{c} ) = {\sum }_{{v}_{i} ∈ {V}_{f}} ( \vert {x}_{c} - {x}_{i} \vert + \vert {y}_{c} - {y}_{i} \vert )\end{matrix} & ( 2 )\end{matrix}$$

In the above, v_{c} is a correction candidate vector; V_{f} is a set consisting of the motion vectors of the sub-blocks in the filter window; x_{c}, y_{c} are respectively a horizontal pixel direction component (X component) and a vertical pixel direction component (Y component); xᵢ, yᵢ are respectively an X component and a Y component of a motion vector vᵢ belonging to the set V_{f}; dif(v_{c}) is a function that outputs the sum of the Manhattan distances between motion vectors v_{c} and vᵢ; arg min(dif(v_{c})) gives the v_{c} that minimizes dif(v_{c}) as the correction vector vₙ. Selecting the correction vector vₙ from the correction candidate vectors v_{c} belonging to the set V_{f} in this way reliably avoids generating a motion vector representing non-existent motion as a correction vector. An optimization process may be carried out, such as weighting the motion vectors of the sub-blocks as a function of their position in the filter window. For some spatial distributions of the motion vectors of the sub-blocks within the filter window, however, the process of calculating the correction vector vₙ may be executed without the requirement that the correction candidate vector v_{c} must belong to the set V_{f}.

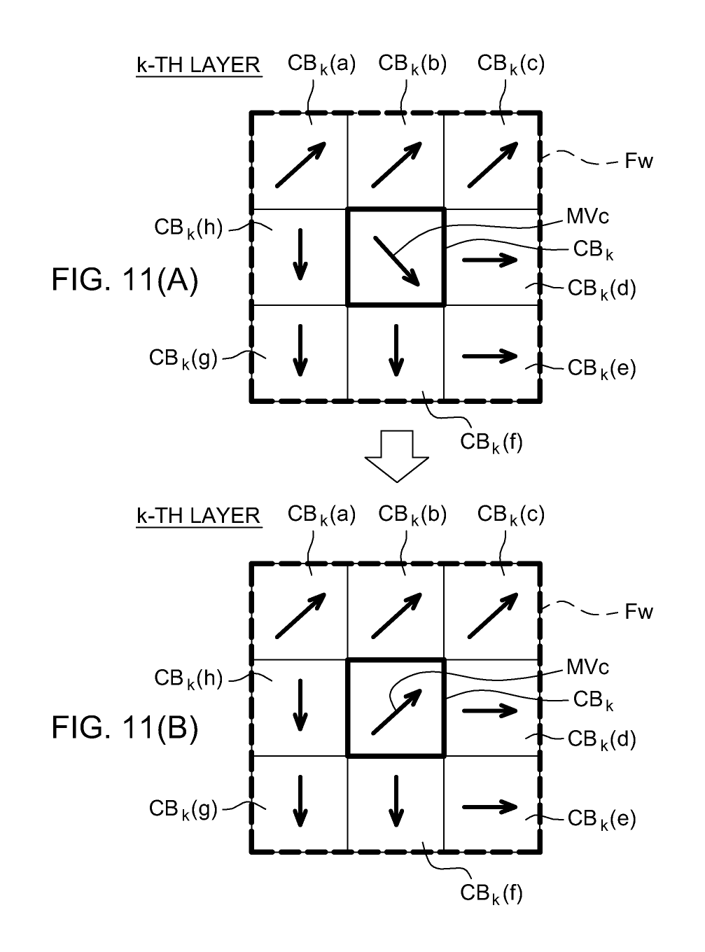

FIGS. 11(A) and 11(B) are drawings schematically showing how a sub-block of interest CBₖ is corrected by use of a motion vector corrector 137ₖ having a filter window Fw of 3×3 pixels. FIG. 11(A) shows the state before correction and FIG. 11(B) shows the state after correction. As shown in FIG. 11(A), the direction of the motion vector MV_{c} of the sub-block of interest CBₖ deviates greatly from the directions of the motion vectors of the surrounding sub-blocks CBₖ(a) to CBₖ(h). When the filtering process (correction) based on the motion vectors of the surrounding sub-blocks CBₖ(a) to CBₖ(h) is carried out, as shown in FIG. 11(B), the sub-block of interest CBₖ acquires a motion vector MV_{c} indicating substantially the same direction as the motion vectors of adjoining sub-blocks CBₖ(a) to CBₖ(c).

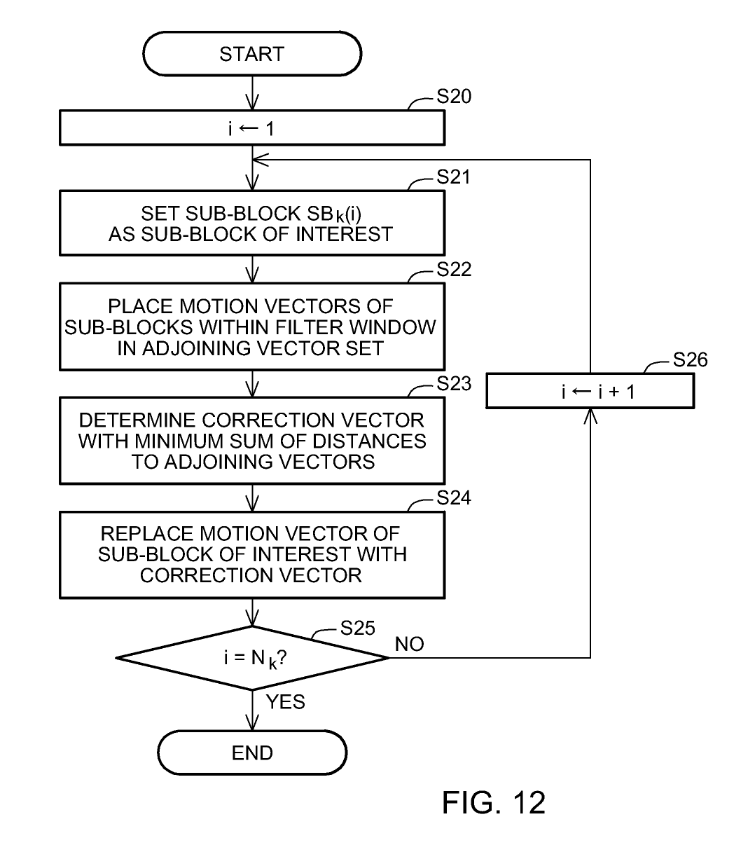

FIG. 12 is a flowchart schematically illustrating the procedure followed by the motion vector corrector 137ₖ in the motion vector correction process. As shown in FIG. 12, the motion vector corrector 137ₖ first initializes the sub-block number i to ‘1’ (step S20), and sets the i-th sub-block SBₖ(i) as the sub-block of interest CBₖ (step S21). Then the motion vector corrector 137ₖ places the motion vectors of the adjoining sub-blocks within the filter window centered on the sub-block of interest CBₖ in the set V_{f} (step S22). Next, the motion vector corrector 137ₖ calculates a sum of distances between the motion vectors belonging to set V_{f} and the motion vector of the sub-block of interest CBₖ and determines a correction vector that minimizes the sum (step S23). The motion vector corrector 137ₖ then replaces the motion vector of the sub-block of interest CBₖ with the correction vector (step S24).

After that, the motion vector corrector 137ₖ determines whether or not the sub-block number i has reached the total number Nₖ of sub-blocks belonging to the k-th layer (step S25); if the sub-block number i has not reached the total number Nₖ (No in step S25), the sub-block number i is incremented by 1 (step S26), and the process returns to step S21. When the sub-block number i reaches the total number Nₖ (Yes in step S25), the motion vector correction process ends.

As described above, each hierarchical processing section 133ₖ generates higher density motion vectors MVₖ based on the motion vectors MVₖ₌₁ input from the previous stage, and outputs them to the next stage. The hierarchical processing section 133_{N} in the final stage outputs pixel motion vectors MV_{N} as the motion vectors MV.

As described above, the motion vector densifier 130 in the first embodiment hierarchically subdivides each of the blocks MB(1), MB(2), . . . , thereby generating multiple layers of sub-blocks SB₁(1), SB₁(2), . . . , SB₂(1), SB₂(2), . . . , SB₃(1), SB₃(2), . . . , while generating motion vectors MV₁, MV₂, . . . , MV_{N} in stages, gradually increasing the density of the motion vectors as it advances to higher layers in the hierarchy. Accordingly, it is possible to generate dense motion vectors MV that are less affected by noise and periodic spatial patterns occurring in the image.

The motion vectors MV₁, MV₂, . . . , MV_{N} determined on the multiple layers are corrected by the motion vector correctors 137₁ to 137_{N}, so in each stage, it is possible to prevent erroneous motion vectors from being transferred to the next stage. Accordingly, motion vectors (pixel motion vectors) MV with high estimation accuracy can be generated from the block motion vectors MV₀.

The motion vector densifier 130 as shown in FIG. 4 in this embodiment has multiple hierarchical processing sections 133₁ to 133_{N}, but these hierarchical processing sections 133₁ to 133_{N} may be implemented either by multiple hardware-structured processing units or by a single processing unit performing a recursive process.

### Second Embodiment

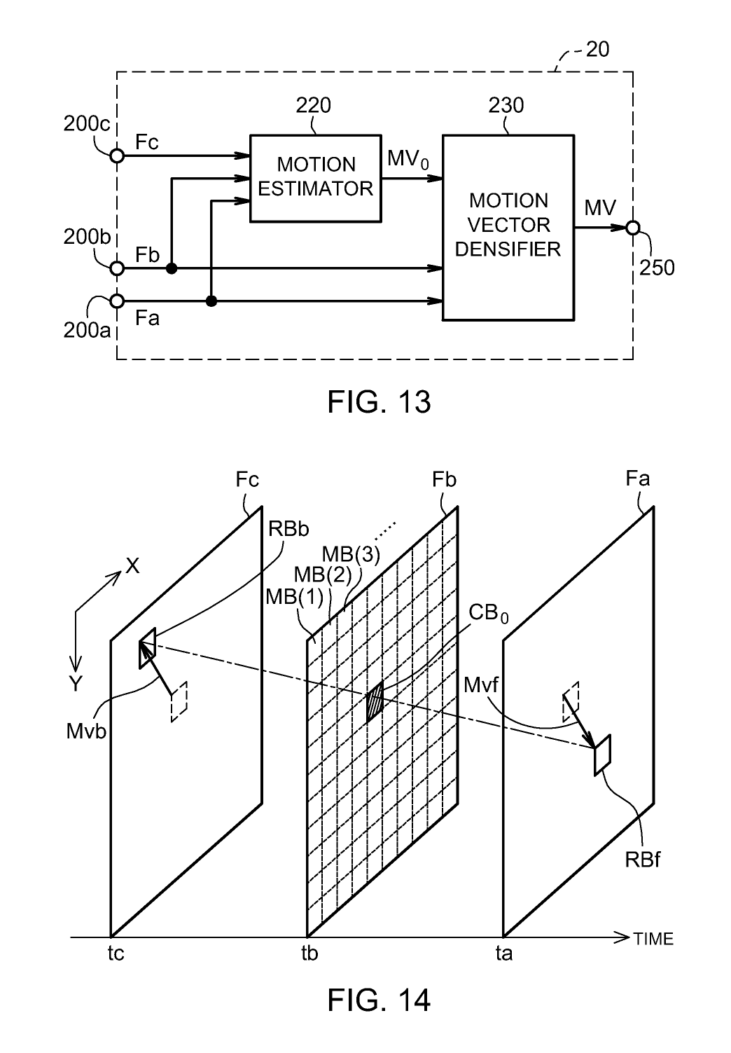

Next, a second embodiment of the invention will be described. FIG. 13 is a functional block diagram schematically illustrating the structure of the motion vector detection device 20 in the second embodiment.

The motion vector detection device 20 has input units 200a, 200b, and 200c to which three temporally consecutive frames Fa, Fb, and Fc among a series of frames forming a moving image are input, respectively. The motion vector detection device 20 also has a motion estimator 220 for detecting block motion vectors MV₀ from the input frames Fa, Fb, and Fc, a motion vector densifier 230 for generating pixel motion vectors MV (with one-pixel precision) based on the block motion vectors MV₀, and an output unit 250 for output of the motion vectors MV. The function of the motion vector densifier 230 is identical to the function of the motion vector densifier 130 in the first embodiment.

FIG. 14 is a drawing schematically illustrating exemplary locations of the three frames Fa, Fb, Fc on the temporal axis. The frames Fa, Fb, Fc are assigned equally spaced times ta, tb, tc, which are identified by timestamp information. In this embodiment, the motion estimator 220 uses frame Fb as the frame of interest and uses the two frames Fa and Fc temporally preceding and following frame Fb as reference frames.

The motion estimator 220 divides the frame of interest Fb into multiple blocks (of, for example, 8×8 pixels or 16×16 pixels) MB(1), MB(2), MB(3), . . . , as shown in FIG. 14, takes each of these blocks MB(1), MB(2), MB(3), . . . in turn as the block of interest CB₀, and estimates the motion of the block of interest CB₀. Specifically, the motion estimator 220 searches in the reference frames Fa and Fc for a respective pair of reference blocks RBf and RBb that are most highly correlated with the block of interest CB₀ in the frame of interest Fb, and detects the displacement in the spatial direction between the block of interest CB₀ and each of the reference blocks RBf and RBb as the motion vectors MVf and MVb of the block of interest CB₀. Since the block of interest CB₀ and reference blocks RBf and RBb are spatiotemporally aligned (in the space defined by the temporal axis, the X-axis, and the Y-axis), the position of one of the two reference blocks RBf and RBb depends on the position of the other one of the two reference blocks. The reference blocks RBf and RBb are point-symmetric with respect to the block of interest CB₀.

As the method of detecting the motion vector Mvf or Mvb, the known block matching method can be used as in the first embodiment. With the block matching method, in order to evaluate the degree of correlation between the pair of reference blocks RBf and RBb and the block of interest CB₀, an evaluation value based on their similarity or dissimilarity is determined. In this embodiment, a value obtained by adding the similarity between the reference block RBf and the block of interest CB₀ to the similarity between the reference block RBb and the block of interest CB₀ can be used as the evaluation value, or a value obtained by adding the dissimilarity between the reference block RBf and the block of interest CB₀ to the dissimilarity between the reference block RBb and the block of interest CB₀ can be used as the evaluation value. To reduce the amount of computation, the reference blocks RBf and RBb are preferably searched for in a restricted range centered on the position corresponding to the position of the block of interest CB₀ in the frame.

Frames Fa, Fb, and Fc need not be spaced at equal intervals on the temporal axis. If the spacing is unequal, the reference blocks RBf and RBb are not point-symmetric with respect to the block of interest CB₀. It is desirable to define the positions of the reference blocks RBf and RBb on the assumption that the block of interest CB₀ moves in a straight line at a constant velocity. However, if frames Fa, Fb, and Fc straddle the timing of a great change in motion, the motion estimation accuracy is very likely to be lowered, so the time intervals ta-tb and tb-tc are preferably short and the difference between them is preferably small.

As described above, the motion vector detection device 30 in the second embodiment uses three frames Fa, Fb, Fc to generate motion vectors MV₀ with high estimation accuracy, so the motion vector densifier 330 can generate dense motion vectors MV with higher estimation accuracy than in the first embodiment.

The motion estimator 220 in this embodiment carries out motion estimation based on three frames Fa, Fb, Fc, but alternatively, the configuration may be altered to carry out motion estimation based on four frames or more.

### Third Embodiment

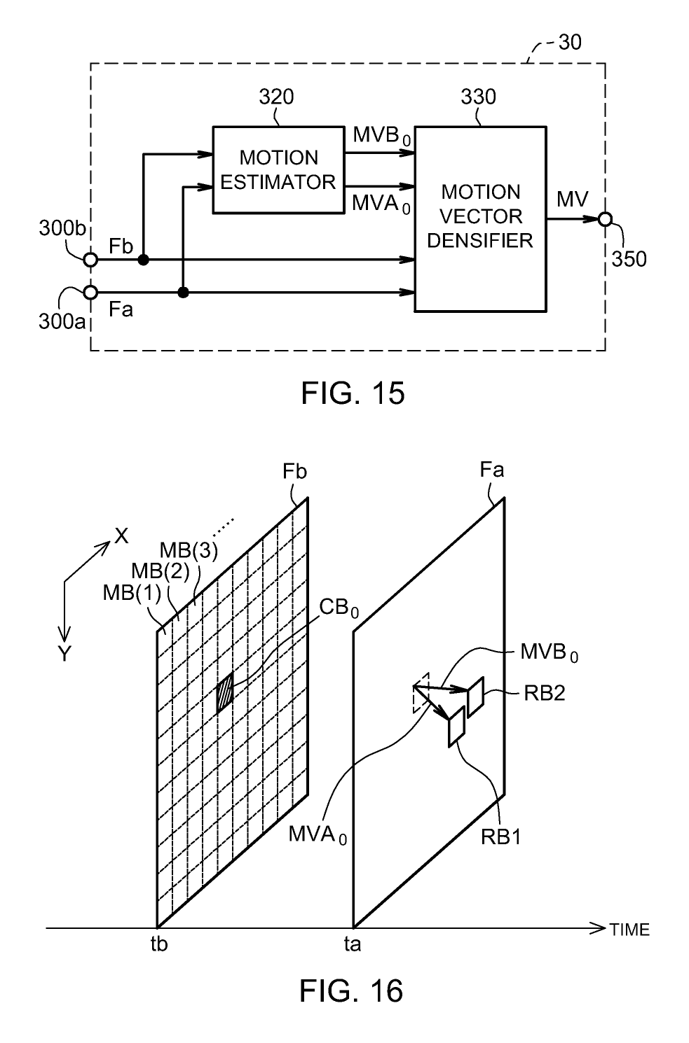

Next, a third embodiment of the invention will be described. FIG. 15 is a functional block diagram schematically illustrating the structure of the motion vector detection device 30 in the third embodiment.

The motion vector detection device 30 has input units 300a and 300b to which temporally distinct first and second frames Fa and Fb are input, respectively, from among a series of frames forming a moving image. The motion vector detection device 30 also has a motion estimator 320 that detects block motion vectors MVA₀ and MVB₀ from the input first and second frames Fa and Fb, a motion vector densifier 330 that generates pixel motion vectors MV (with one-pixel precision) based on the motion vectors MVA₀ and MVB₀, and an output unit 350 for external output of these motion vectors MV.

FIG. 16 is a drawing schematically showing exemplary locations of the first frame Fa and second frame Fb on the temporal axis. The first frame Fa and the second frame Fb are respectively assigned times to and tb, which are identified by timestamp information. The motion vector detection device 30 in this embodiment uses the second frame Fb as the frame of interest and uses the first frame Fa, which is input temporally after the second frame Fb, as a reference frame.

As schematically shown in FIG. 16, the motion estimator 320 divides the frame of interest Fb into multiple blocks (of, for example, 8×8 pixels or 16×16 pixels) MB(1), MB(2), MB(3), . . . . Then the motion estimator 320 takes each of these blocks MB(1), MB(2), MB(3), . . . in turn as the block of interest CB₀, estimates the motion of the block of interest CB₀ from the frame of interest Fb to the reference frame Fa, and thereby detects the two motion vectors MVA₀, MVB₀ ranking highest in order of reliability. Specifically, the motion estimator 320 searches for the reference block RB1 most highly correlated with the block of interest CB₀ and the reference block RB2 next most highly correlated with the reference frame Fa. Then the displacement in the spatial direction between the block of interest CB₀ and reference block RB1 is detected as motion vector MVA₀, and the difference in the spatial direction between the block of interest CB₀ and reference block RB2 is detected as motion vector MVB₀.

As the method of detecting the motion vectors MVA₀, MVB₀, the known block matching method may be used. For example, when a sum of absolute differences (SAD) representing the dissimilarity of a sub-block pair is used, the motion vector with the least SAD can be detected as the first motion vector MVA₀, and the motion vector with the next least SAD can be detected as the second motion vector MVB₀.

Like the motion vector densifier 130 in the first embodiment, the motion vector densifier 330 subdivides each of the blocks MB(1), MB(2), . . . , thereby generating first to N-th layers of sub-blocks. On the basis of the block motion vectors MVA₀ and MVB₀, the motion vector densifier 330 then generates the two motion vectors ranking highest in order of reliability for each sub-block on each of the layers except the N-th layer, which is the final stage, and generates the motion vector MV with the highest reliability on the N-th (final-stage) layer. Here the reliability of a motion vector is determined from the similarity or dissimilarity between the sub-block of interest and the reference sub-block used to detect the motion vector. The higher the similarity of the sub-block pair (in other words, the lower the dissimilarity of the sub-block pair) is, the higher the reliability of the motion vector becomes.

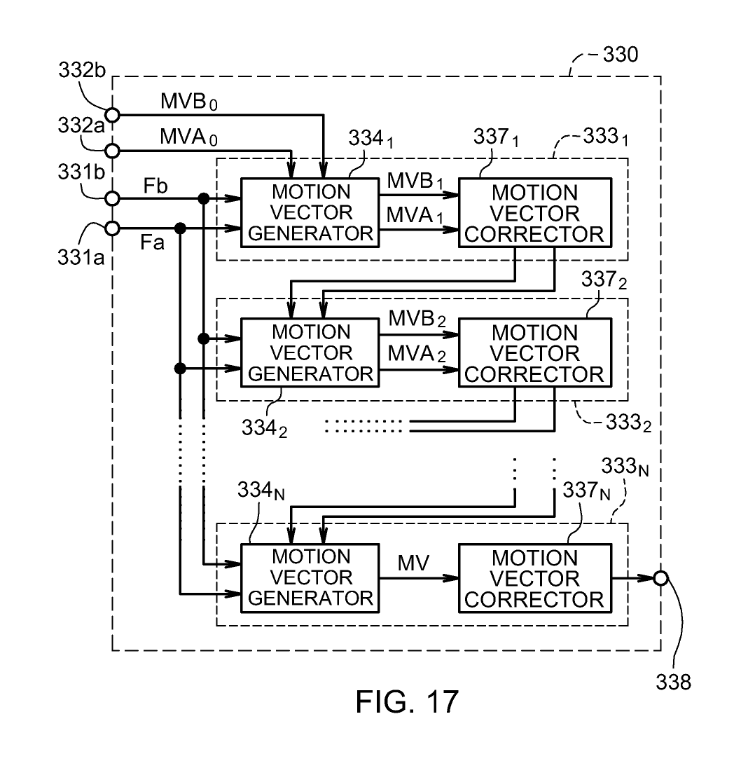

FIG. 17 is a functional block diagram schematically illustrating the structure of the motion vector densifier 330. As shown in FIG. 17, the motion vector densifier 330 has input units 332a, 332b to which the two highest-ranking motion vectors MVA₀ and MVB₀ are input, respectively, input units 331a, 331b to which the reference frame Fa and the frame of interest Fb are input, respectively, hierarchical processing sections 333₁ to 333_{N} for the first to N-th layers (N being an integer equal to or greater than 2), and an output unit 338 for output of densified motion vectors MV. Each hierarchical processing section 333ₖ (k being an integer from 1 to N) has a motion vector generator 334ₖ and a motion vector corrector 337ₖ.

The basic operations of the hierarchical processing sections 333₁ to 333_{N} are all the same. The processing in the hierarchical processing sections 333₁ to 333_{N} will now be described in detail, using the blocks MB(1), MB(2), . . . processed in the first hierarchical processing section 333₁ as 0-th layer sub-blocks SB₀(1), SB₀(2), . . . .

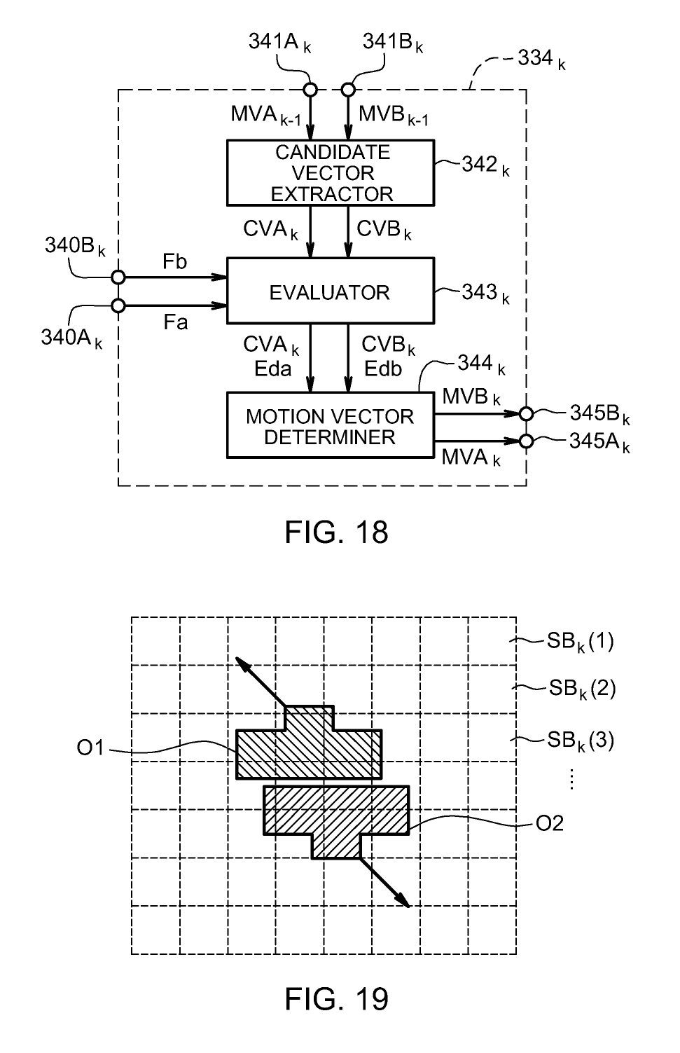

FIG. 18 is a functional block diagram schematically illustrating the structure of the motion vector generator 334ₖ in the hierarchical processing section 333ₖ. As shown in FIG. 18, the motion vector generator 334ₖ has input units 341Aₖ, 341Bₖ, which receive the two highest-ranking motion vectors MVAₖ₌₁, MVBₖ₌₁ input from the previous stage, input units 340Aₖ, 340Bₖ, to which the reference frame Fa and frame of interest Fb are input, a candidate vector extractor 342ₖ, an evaluator 343ₖ, and a motion vector determiner 344ₖ.

The candidate vector extractor 342ₖ takes sub-blocks SBₖ(1), SBₖ(2), . . . one by one in turn as the sub-block of interest CBₖ, and extracts a candidate vector CVAₖ for the sub-block of interest CBₖ from the set of first-ranking motion vectors MVAₖ₌₁ of the sub-blocks SBₖ₌₁(1), SBₖ₌₁(2), . . . on the higher layer which is at one level higher than the current layer. At the same time, the candidate vector extractor 342ₖ extracts a candidate vector CVBₖ for the sub-block of interest CBₖ from the set of second-ranking motion vectors MVBₖ₌₁ of the sub-blocks SBₖ₌₁(1), SBₖ₌₁(2), . . . on the higher layer which is at one level higher than the current layer. The extracted candidate vectors CVAₖ and CVBₖ are sent to the evaluator 343ₖ. The method of extracting the candidate vectors CVAₖ and CVBₖ is the same as the extraction method used by the candidate vector extractor 142ₖ (FIG. 5) in the first embodiment.

After the candidate vectors CVAₖ, CVBₖ are extracted, the evaluator 343ₖ extracts a reference sub-block from the reference frame by using candidate vector CVAₖ, and calculates an evaluation value Eda based on the similarity or dissimilarity between this reference sub-block and the sub-block of interest CBₖ. At the same time, the evaluator 343ₖ extracts a reference sub-block from the reference frame by using candidate vector CVBₖ, and calculates an evaluation value Edb based on the similarity or dissimilarity between this reference sub-block and the sub-block of interest CBₖ. The method of calculating the evaluation values Eda, Edb is the same as the method of calculating the evaluation value Ed used by the evaluator 143ₖ (FIG. 5) in the first embodiment.

On the basis of the evaluation values Eda, Edb, the motion vector determiner 344ₖ then selects, from the candidate vectors CVAₖ, CVBₖ, a first motion vector MVAₖ with highest reliability and a second motion vector MVBₖ with next highest reliability. These motion vectors MVAₖ, MVBₖ are output via output units 345Aₖ, 345Bₖ, respectively, to the next stage. In the last stage, however, the motion vector determiner 344_{N} in the hierarchical processing section 333_{N} selects the motion vector MV with the highest reliability from among the CVA_{N}, CVB_{N} supplied from the preceding stage.

The motion vector corrector 337ₖ in FIG. 17 has a filter function that concurrently corrects motion vector MVAₖ and motion vector MVBₖ. The method of correcting motion vectors MVAₖ, MVBₖ is the same as the method of correcting the motion vector MVₖ used by the motion vector corrector 337ₖ in the first embodiment. When erroneous motion vectors MVAₖ, MVBₖ are output from the motion vector generator 334ₖ, this filtering function can prevent the erroneous motion vectors MVAₖ, MVBₖ from being transferred to the hierarchical processing section 333ₖ₊₁ in the next stage.

As set forth above, based on the pairs of two highest-ranking motion vectors MVAₖ₌₁, MVBₖ₌₁ input from the previous stage, each hierarchical processing section 333ₖ generates motion vectors MVAₖ, MVBₖ with higher density and outputs them to the next stage. The hierarchical processing section 333_{N} outputs motion vectors with the highest reliability as the pixel motion vectors MV.

As described above, the motion vector densifier 330 in the third embodiment hierarchically subdivides each of the sub-blocks MB(1), MB(2), . . . , thereby generating sub-blocks SB₁(1), SB₁(2), . . . , SB₂(1), SB₂(2), . . . , SB_{N}(1), SB_{N}(2), . . . on multiple layers, and generates motion vectors MVA₁, MVB₁, MVA₂, MVB₂, . . . , MVA_{N-1}, MVB_{N-1}, MV in stages, gradually increasing the density of the motion vectors as it advances to higher layers in the hierarchy. Accordingly, it is possible to generate dense motion vectors MV that are less affected by noise and periodic spatial patterns occurring in the image.

The motion vectors MVA₁, MVB₁, MVA₂, MVB₂, . . . , MVA_{N-1}, MVB_{N-1}, MV determined on the multiple layers are corrected by the motion vector correctors 337₁ to 337_{N}, so in each stage, it is possible to prevent erroneous motion vectors from being transferred to the next stage. Accordingly, dense motion vectors (pixel motion vectors) MV with high estimation accuracy can be generated from the block motion vectors MV₀.

In addition, as described above, the motion estimator 320 detects the two highest-ranking motion vectors MVA₀, MVB₀ for each of the blocks MB(1), MB(2), . . . , and each hierarchical processing section 333ₖ (k=1 to N−1) in the motion vector densifier 330 also generates the two highest-ranking motion vectors MVAₖ, MVBₖ for each of the sub-blocks SBₖ(1), SBₖ(2), . . . . This enables the motion vector determiner 344ₖ in FIG. 18 to select more likely motion vectors from more candidate vectors CVAₖ, CVBₖ than in the first embodiment, so the motion vector estimation accuracy can be improved.

As shown in FIG. 19, the boundaries of sub-blocks may not always match the boundaries of objects O1, O2, and objects O1, O2 may move in mutually differing directions. In this case, if a single motion vector is generated for each of the sub-blocks SBₖ(1), SBₖ(2), . . . , information on the two directions of motion of objects O1, O2 might be lost. Since the motion vector detection device 30 in this embodiment generates the two motion vectors ranking first and second in reliability for each of the blocks MB(1), MB(2), . . . and sub-blocks SBₖ(1), SBₖ(2), SBₖ(3), . . . (k=1 to N−1), it can prevent the loss of information on motion in multiple directions that might be present in blocks MB(1), MB(2), . . . or sub-blocks SBₖ(1), SBₖ(2), . . . . The motion vector estimation accuracy can therefore be further improved, as compared to the first embodiment.

The motion estimator 320 and hierarchical processing section 333ₖ (k=1 to N=1) each generate two highest-ranking motion vectors, but this is not a limitation. The motion estimator 320 and hierarchical processing section 333ₖ may each generate three or more motion vectors ranking highest in order of reliability.

The motion estimator 320 in this embodiment detects block motion vectors MVA₀, MVB₀ based on two frames Fa, Fb, but alternatively, like the motion estimator 220 in the second embodiment, it may detect motion vectors MVA₀, MVB₀ based on three or more frames.

### Fourth Embodiment

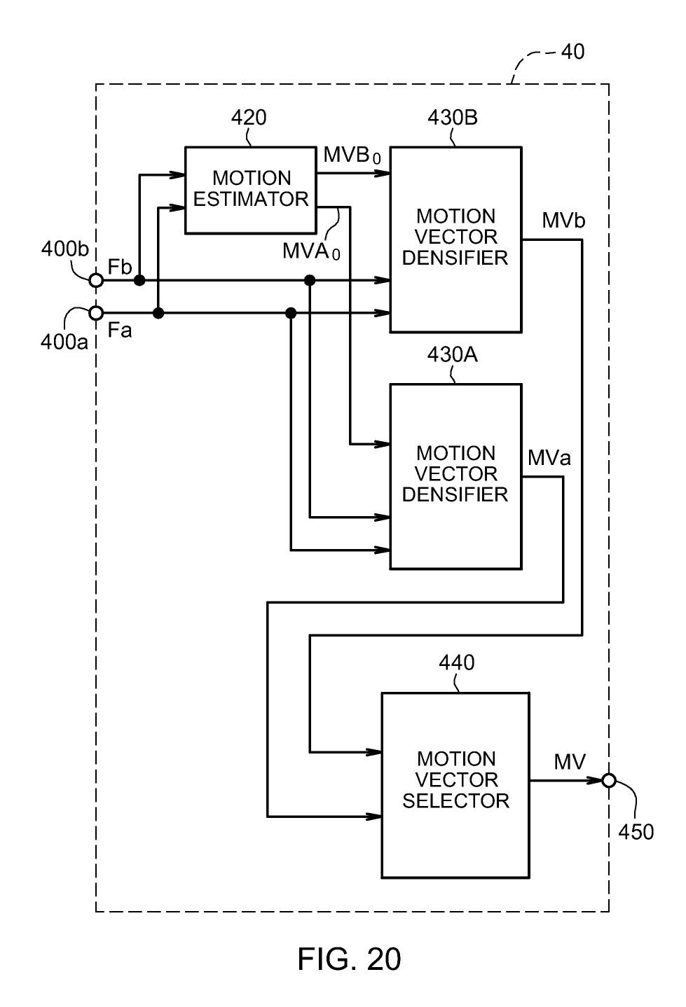

Next, a fourth embodiment of the invention will be described. FIG. 20 is a functional block diagram schematically showing the structure of the motion vector detection device 40 in the fourth embodiment.

The motion vector detection device 40 has input units 400a, 400b to which temporally distinct first and second frames Fa, Fb among a series of frames forming a moving image are input, respectively, and a motion estimator 420 that detects block motion vectors MVA₀, MVB₀ from the input first and second frames Fa, Fb. The motion estimator 420 has the same function as the motion estimator 320 in the third embodiment.

The motion vector detection device 40 also has a motion vector densifier 430A for generating pixel motion vectors MVa (with one-pixel precision) based on the motion vectors MVA₀ of highest reliability, a motion vector densifier 430B for generating pixel motion vectors MVb based on the motion vectors MVB₀ of next highest reliability, a motion vector selector 440 for selecting one of these candidate vectors MVa, MVb as a motion vector MV, and an output unit 450 for external output of motion vector MV.

Like the motion vector densifier 130 in the first embodiment, the motion vector densifier 430A has the function of hierarchically subdividing each of the blocks MB(1), MB(2), . . . derived from the frame of interest Fb, thereby generating first to N-th layers of multiple sub-blocks, and generating a motion vector for each sub-block on each layer based on block motion vectors MVA₀. The other motion vector densifier (sub motion vector densifier) 430B, also like the motion vector densifier 130 in the first embodiment, has the function of hierarchically subdividing each of the blocks MB(1), MB(2), . . . derived from the frame of interest Fb, thereby generating first to N-th layers of multiple sub-blocks, and generating a motion vector for each sub-block on each layer based on the block motion vectors MVB₀.

The motion vector selector 440 selects one of the candidate vectors MVa, MVb as the motion vector MV, and externally outputs the motion vector MV via the output unit 450. For example, the one of the candidate vectors MVa, MVb that has the higher reliability, based on the similarity or dissimilarity between the reference sub-block and the sub-block of interest, may be selected, although this is not a limitation.

As described above, the motion vector detection device 40 in the fourth embodiment detects the two highest-ranking motion vectors MVA₀, MVB₀ for each of the blocks MB(1), MB(2), . . . and generates two dense candidate vectors MVa, MVb, so it can output whichever of the candidate vectors MVa, MVb has the higher reliability as motion vector MV. As in the third embodiment, it is possible to prevent the loss of information on motion in multiple directions that may be present in each of the blocks MB(1), MB(2), . . . . Accordingly, the motion vector estimation accuracy can be further improved, as compared with the first embodiment.

The motion estimator 420 generates two highest-ranking motion vectors MVA₀, MVB₀, but this is not a limitation. The motion estimator 420 may generate M motion vectors or more (M being an integer equal to or greater than 3) ranking highest in order of reliability. In this case, it is only necessary to incorporate M motion vector densifiers for generating M densified candidate vectors from M motion vectors.

### Fifth Embodiment

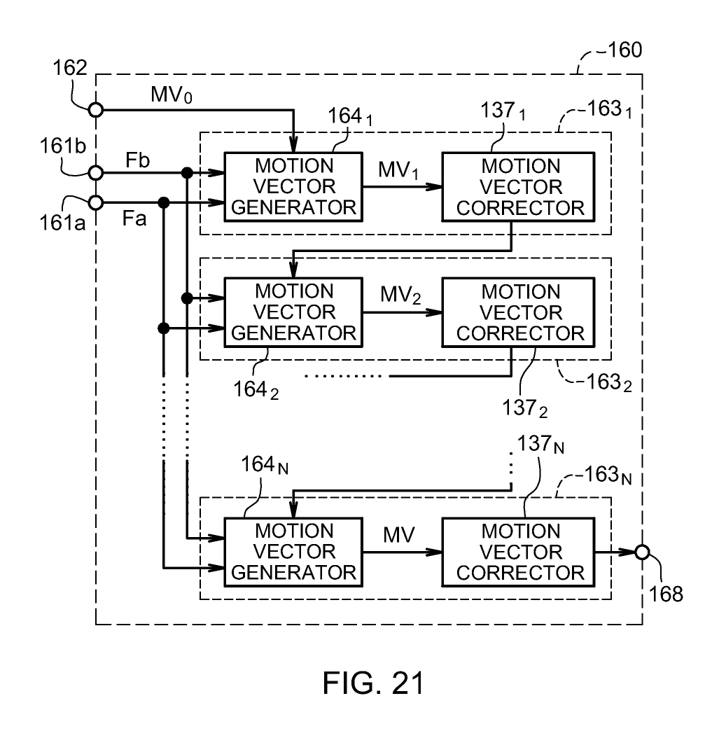

Next a fifth embodiment of the invention will be described. FIG. 21 is a functional block diagram schematically illustrating the structure of the motion vector densifier 160 in the fifth embodiment. The motion vector detection device in this embodiment has the same structure as the motion vector detection device 10 in the first embodiment, except that it includes the motion vector densifier 160 in FIG. 21 instead of the motion vector densifier 130 in FIG. 1.

As shown in FIG. 21, the motion vector densifier 160 has an input unit 162 to which a block motion vector MV₀ is input, input units 161a, 161b to which the reference frame Fa and the frame of interest Fb are input, first to N-th hierarchical processing sections 163₁ to 163_{N} (N being an integer equal to or greater than 2), and an output unit 168 from which pixel motion vectors MV are output. Each hierarchical processing section 163ₖ (k being an integer from 1 to N) has a motion vector generator 134ₖ and a motion vector corrector 137ₖ; the motion vector corrector 137ₖ in FIG. 21 has the same structure as the motion vector corrector 137ₖ in FIG. 4.

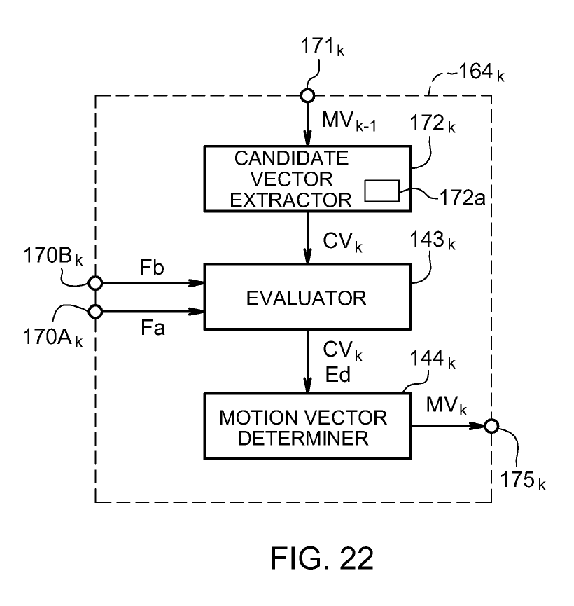

FIG. 22 is a functional block diagram schematically illustrating the structure of the k-th motion vector generator 164ₖ in the motion vector densifier 160. As shown in FIG. 22, the motion vector generator 164ₖ has an input unit 171ₖ that receives a motion vector MVₖ₌₁ input from the previous stage, input units 170Aₖ, 170Bₖ to which the reference frame Fa and the frame of interest Fb are input, a candidate vector extractor 172ₖ, an evaluator 143ₖ, and a motion vector determiner 144ₖ; the evaluator 143ₖ and motion vector determiner 144ₖ in FIG. 22 have the same structures as the evaluator 143ₖ and motion vector determiner 144ₖ in FIG. 5. The candidate vector extractor 172ₖ in this embodiment has a candidate vector extractor 172a for detecting the position of a sub-block of interest relative to its parent sub-block (i.e., the sub-block on the higher layer which is at one level higher than the current layer).

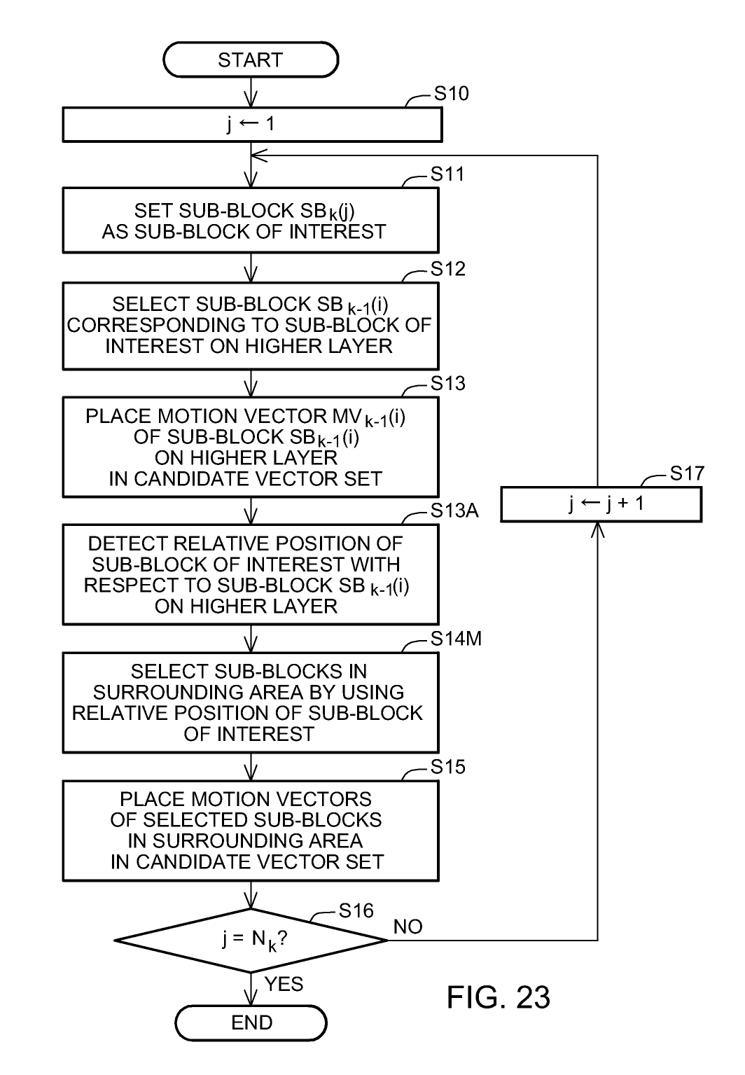

FIG. 23 is a flowchart schematically illustrating the procedure followed in the candidate vector extraction process executed by the candidate vector extractor 172ₖ. As shown in FIG. 23, the candidate vector extractor 172ₖ first initializes the sub-block number j to ‘1’ (step S10), and sets the j-th sub-block SBₖ(j) as the sub-block of interest CBₖ (step S11). Then, the candidate vector extractor 172ₖ selects sub-block SBₖ₌₁(i) that is the parent of the sub-block of interest CBₖ from among the sub-blocks on the higher layer, i.e., the (k=1)-th layer which is at one level higher than the current layer (step S12). Next candidate vector extractor 172ₖ places the motion vector MV₌₁(i) of this sub-block SBₖ₌₁(i) in the candidate vector set Vₖ(j) (step S13).

After that, the candidate vector extractor 172a in the candidate vector extractor 172ₖ detects the relative position of the sub-block of interest CBₖ with respect to the sub-block SBₖ₌₁(i) on the higher layer which is at one level higher than the current layer (step S13A). For example, in the example in FIGS. 7(A) and 7(B), the parent of sub-block CBₖ on the k-th layer is sub-block SBₖ₌₁(i) on the (k=1)-th layer. In this case, the candidate vector extractor 172a may detect that the sub-block of interest CBₖ is positioned below and to the right of sub-block SBₖ₌₁(i) on the (k=1)-th layer. In the example in FIGS. 9(A) and 9(B), the sub-block of interest CBₖ is located at a position nonadjacent to the vertices of the dotted-line box corresponding to the boundary of sub-block SBₖ₌₁(i). In this case, the candidate vector extractor 172a can output the positional information of the box vertex spatially nearest to the sub-block of interest CBₖ.

Next, the candidate vector extractor 142ₖ selects a group of sub-blocks in the area surrounding the parent sub-block SBₖ₌₁(i) on the (k=1)-th layer by using the relative position detected in step S13A (step S14M), and places the motion vectors of the sub-blocks in this group in the candidate vector set Vₖ(j) (step S15). For example, in the example in FIGS. 7(A) and 7(B), by using the relative position detected in step S13A, the candidate vector extractor 142ₖ can select, from among the adjoining sub-blocks SBₖ₌₁(a) to SBₖ₌₁(h) adjacent to the sub-block SBₖ₌₁(i) which is the parent of the sub-block of interest CBₖ, sub-blocks SBₖ₌₁(c) to SBₖ₌₁(g), which are adjacent to two of the four boundary lines of sub-block SBₖ₌₁(i), these being the two lines including the lower right vertex of the boundary (step S14M). In the case of FIGS. 9(A) and 9(B), it is similarly possible to select sub-blocks SBₖ₌₁(c) to SBₖ₌₁(g) from among the surrounding sub-blocks SBₖ₌₁(a) to SBₖ₌₁(h) adjacent to sub-block SBₖ₌₁(i) by using the relative position detected in step S13A (step S14M). The sub-blocks selected in step S14M are limited to the sub-blocks SBₖ₌₁(d) to SBₖ₌₁(f) adjoining sub-block SBₖ₌₁(i), but this is not a limitation; sub-blocks nonadjacent to sub-block SBₖ₌₁(i) may be selected.

After step S15, the candidate vector extractor 172ₖ determines whether or not the sub-block number j has reached the total number Nₖ of sub-blocks belonging to the k-th layer (step S16); if the sub-block number j has not reached the total number Nₖ (No in step S16), the sub-block number j is incremented by 1 (step S17), and the process returns to step S11. When the sub-block number j reaches the total number Nₖ (Yes in step S16), the candidate vector extraction process ends.

As described above, the candidate vector extractor 172ₖ can use the detection result from the candidate vector extractor 172a to select, from among the sub-blocks located in the surrounding area of the parent SBₖ₌₁(i) of the sub-block of interest CBₖ, a sub-block that, spatially, is relatively near the sub-block of interest CBₖ (step S14M). Accordingly, compared with the candidate vector extraction process (FIG. 6) in the first embodiment, the number of candidate vectors can be reduced to reduce the processing load of the evaluator 143ₖ in the next stage or to speed up the operation. When the candidate vector extractor 172ₖ is configured by hardware, the circuit size can be reduced.

The structure of the motion vector densifier 160 in this embodiment is applicable to the motion vector densifiers 230, 330, 430A, and 430B in the second, third, and fourth embodiments.

### Sixth Embodiment

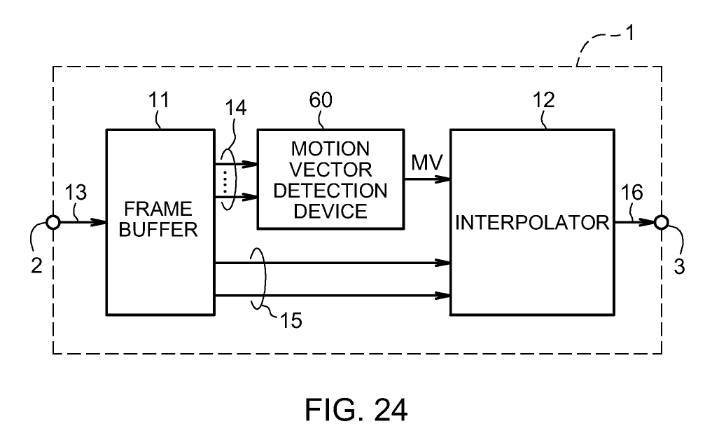

Next, a sixth embodiment of the invention will be described. FIG. 24 is a functional block diagram schematically illustrating the structure of the frame interpolation device 1 in the sixth embodiment.

As shown in FIG. 24, the frame interpolation device 1 includes a frame buffer 11 for temporally storing a video signal 13 input via the input unit 2 from an external device (not shown), a motion vector detection device 60, and an interpolator 12. The motion vector detection device 60 has the same structure as any one of the motion vector detection devices 10, 20, 30, 40 in the first to fourth embodiments or the motion vector detection device in the fifth embodiment.

The frame buffer 11 outputs a video signal 14 representing a series of frames forming a moving image to the motion vector detection device 60 two or three frames at a time. The motion vector detection device 60 generates pixel motion vectors MV (with one-pixel precision) based on the video signal 14 read and input from the frame buffer 11, and outputs them to the interpolator 12.

The interpolator 12 is operable to use the data 15 of temporally consecutive frames read from the frame buffer 11 to generate interpolated frames between these frames (by either interpolation or extrapolation) based on dense motion vectors MV. An interpolated video signal 16 including the interpolated frames is externally output via the output unit 3.

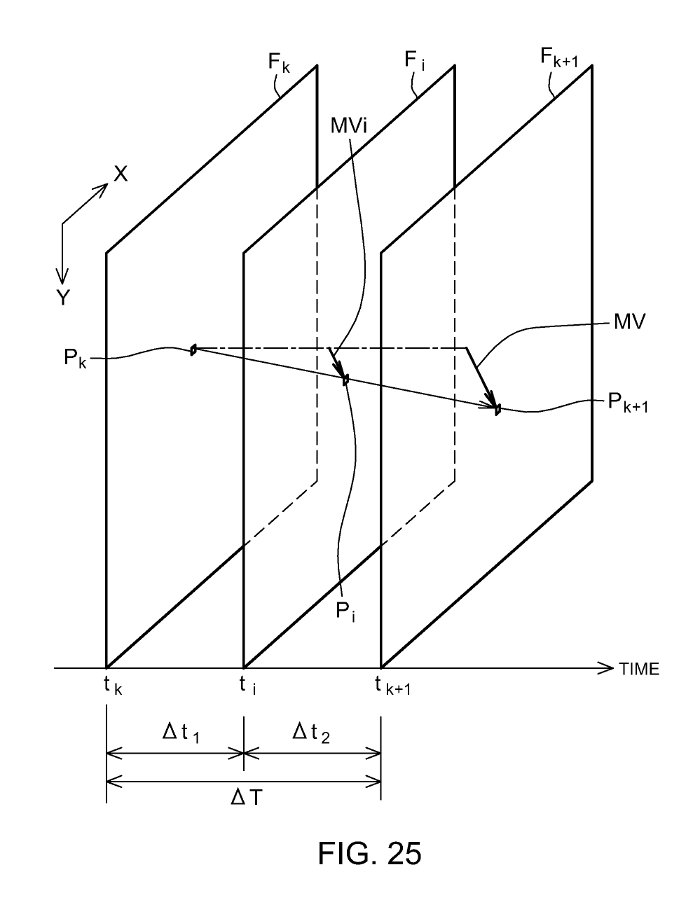

FIG. 25 is a drawing illustrating a linear interpolation method, which is an exemplary frame interpolation method. As shown in FIG. 25, an interpolated frame Fᵢ is generated (linearly interpolated) between temporally distinct frames Fₖ₊₁ and Fₖ. Frames Fₖ₊₁, Fₖ are respectively assigned times tₖ₊₁, tₖ; the time tᵢ of the interpolated frame Fᵢ leads time tₖ by Δt₁ and lags time tₖ₊₁ by Δt₂. The position of pixel Pₖ₊₁ on frame Fₖ₊₁ corresponds to the position of pixel Pₖ on frame Fₖ₊₁ as moved by motion vector MV=(Vx, Vy).

The position of interpolated pixel Pᵢ corresponds to the position of pixel Pₖ on frame Fₖ as moved by motion vector MVi=(Vxi, Vyi). The following equations are true for the X component and Y component of motion vector MVi.

Vxi=Vx·(1−Δt₂/ΔT)

Vyi=Vy·(1−Δt₂/ΔT)

In the above, ΔT=Δt₁+Δt₂. The pixel value of the interpolated pixel Pᵢ may be the pixel value of pixel Pₖ on the frame Fₖ.

The interpolation method is not limited to the linear interpolation method; other interpolation methods suitable to pixel motion may be used.

As described above, the frame interpolation device 1 in the sixth embodiment can perform frame interpolation by using the dense motion vectors MV with high estimation accuracy generated in the motion vector detection device 60, so image disturbances, such as block noise in the boundary parts of an object occurring in an interpolated frame, can be restricted and interpolated frames of higher image quality can be generated.

In order to generate an interpolated frame Fᵢ with higher resolution, the frame buffer 11 may be operable to convert the resolution of each of the frames included in the input video signal 13 to higher resolution. This enables the frame interpolation device 1 to output a video signal 16 of high image quality with a high frame rate and high resolution.

All or part of the functions of the motion vector detection device 60 and interpolator 12 may be realized by hardware structures, or by computer programs executed by a microprocessor.

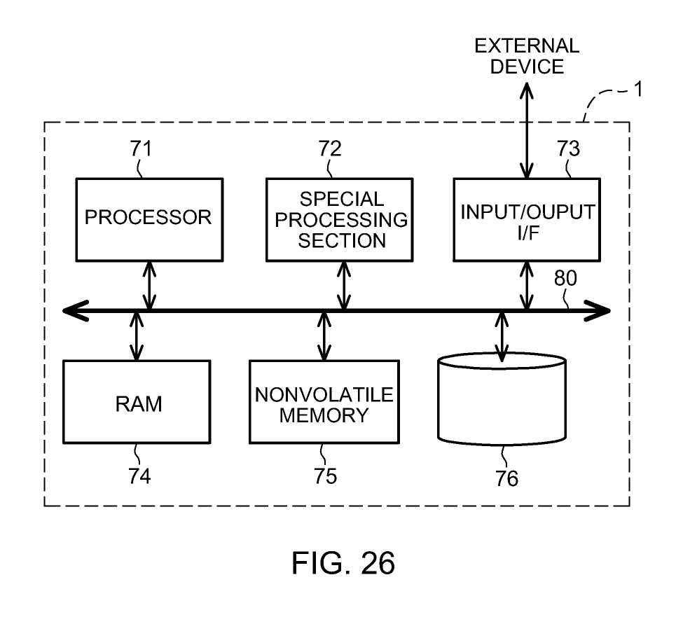

FIG. 26 is a drawing schematically illustrating the structure of a frame interpolation device 1 with functions fully or partially realized by computer programs. The frame interpolation device 1 in FIG. 26 has a processor 71 including a CPU (central processing unit), a special processing section 72, an input/output interface 73, RAM (random access memory) 74, a nonvolatile memory 75, a recording medium 76, and a bus 80. The recording medium 76 may be, for example, a hard disc (magnetic disc), an optical disc, or flash memory.

The frame buffer 11 in FIG. 24 may be incorporated in the input/output interface 73, and the motion vector detection device 60 and interpolator 12 can be realized by the processor 71 or special processing section 72. The processor 71 can realize the function of the motion vector detection device 60 and the function of the interpolator 12 by loading a computer program from the nonvolatile memory 75 or recording medium 76 and executing the program.

### Variations of the First to Sixth Embodiments

Embodiments of the invention have been described above with reference to the drawings, but these are examples illustrating the invention, and other various embodiments can also be employed. For example, in the final output in the first to fifth embodiments, all motion vectors have one-pixel precision, but this is not a limitation. The structure of each of the embodiments may be altered to generate motion vectors MV with non-integer pixel precision, such as half-pixel precision, quarter-pixel precision, or 1.5-pixel precision.

In the motion vector densifier 130 in the first embodiment, as shown in FIG. 4, all the hierarchical processing sections 133₁ to 133_{N} have motion vector correctors 137₁ to 137_{N}, but this is not a limitation. Other embodiments are possible in which at least one hierarchical processing section 133ₘ among the hierarchical processing sections 133₁ to 133_{N} has a motion vector corrector 137ₘ (m being an integer from 1 to N) and other hierarchical processing section 133ₙ (n≠m) do not have motion vector correction units. Regarding the motion vector densifier 330 in the third embodiment, other embodiments are possible in which at least one hierarchical processing section 133ₚ among the hierarchical processing sections 333₁ to 333_{N} has a motion vector corrector 137ₚ (p being an integer from 1 to N) and other hierarchical processing section 133_{g} (q≠p) do not have a motion vector corrector. This is also true of the motion vector densifiers 230, 430A, 430B, and 160 in the second, fourth, and fifth embodiments.

There are no particular limitations on the method of assigning sub-block numbers j to the sub-blocks SBₖ(j); any assignment method may be used.

### REFERENCE CHARACTERS

1 frame interpolation device, 2 input unit, 3 output unit, 10, 20, 30, 40, 50 motion vector detection device, 120, 220, 320, 420 motion estimator, 130, 230, 330, 430A, 430B motion vector densifier, 133₁ to 133_{N}, 333₁ to 333_{N} hierarchical processing sections, 134₁ to 134_{N}, 334₁ to 334_{N} motion vector generators, 137₁ to 137_{N}, 337₁ to 337_{N} motion vector correctors, 142ₖ, 342ₖ candidate vector extractor, 143ₖ, 343ₖ evaluator, 144ₖ, 344ₖ motion vector determiner, 440 motion vector selector, 11 frame buffer, 12 interpolator, 71 processor, 72 special processing section, 73 input/output interface, 74 RAM, 75 nonvolatile memory, 76 recording medium, 80 bus.

1. A motion vector detection device that detects motion in a series of frames constituting a moving image, comprising:
a motion estimator for dividing a frame of interest in the series of frames into a plurality of blocks, and for, taking a frame temporally differing from the frame of interest in the series of frames as a reference frame and taking each of the blocks as a block of interest, searching for a reference block being most highly correlated with the block of interest in the reference frame, and detecting a displacement in a spatial direction between the block of interest and the reference block, thereby detecting one or more motion vectors for the block of interest; and
a motion vector densifier for, using the plurality of blocks as a plurality of sub-blocks on a zeroth layer, hierarchically dividing each of the sub-blocks on the zeroth layer to thereby generate a plurality of sub-blocks on a plurality of layers including a first layer to an N-th layer (N being an integer equal to or greater than 2) and generating a motion vector for each one of the sub-blocks in each layer from the first to the N-th layer; wherein
the motion vector densifier includes:
a motion vector generator for generating a plurality of sub-blocks on each layer from the first to the N-th layer based on parent sub-blocks, the parent sub-blocks being the sub-blocks on a higher layer which is at one level higher than said each layer, and further for taking each sub-block in the plurality of sub-blocks as a sub-block of interest, placing in a candidate vector set the motion vector for the corresponding parent sub-block from which the sub-block of interest is generated, and placing in the candidate vector set the motion vector for the sub-block which is on a same layer of the corresponding parent sub-block and located in an area surrounding the corresponding parent sub-block, and still further for selecting a motion vector for the sub-block of interest from the candidate vector set; and
a motion vector corrector for, on at least one layer to be corrected among the first layer to the N-th layer, taking each of the plurality of sub-blocks on the layer to be corrected as a sub-block to be corrected, and correcting the motion vector of the sub-block to be corrected, based on the motion vectors of neighboring sub-blocks located in an area surrounding the sub-block to be corrected, the motion vector corrector selecting, from among the motion vectors composed of the motion vector of the sub-block to be corrected and the motion vectors of the neighboring sub-blocks, a correction candidate vector that minimizes a sum of distances between the motion vector of the sub-block to be corrected and the motion vectors of the neighboring sub-blocks, and replacing the motion vector of the sub-block to be corrected with the selected correction candidate vector, thereby correcting the motion vector of the sub-block to be corrected.

2. The motion vector detection device of claim 1, wherein the motion vector generator uses the motion vectors as corrected by the motion vector corrector to generate the motion vector of each of the sub-blocks on a lower layer which is at one level lower than the layer to be corrected.

3. (canceled)

4. (canceled)

5. The motion vector detection device of claim 1, wherein
the motion vector generator selects a plurality of motion vectors ranking highest in order of reliability from the candidate vector set as motion vectors for the sub-block of interest.

6. (canceled)

7. The motion vector detection device of claim 1, wherein
the plurality of sub-blocks on each layer from the first layer to the N-th layer are generated by subdivision of each of the plurality of sub-blocks on the layer which is at one level higher than said each layer.

8. (canceled)

9. (canceled)

10. The motion vector detection device of claim 1 wherein, on a basis of results of estimating the motion of each of the blocks, the motion estimator detects M motion vectors ranking highest in order of reliability as the motion vectors for the block of interest (M being an integer equal to or greater than 2).

11. The motion vector detection device of claim 10, further comprising:
a motion vector selector for selecting a motion vector of highest reliability from among M motion vectors generated by M motion vector densifiers for each sub-block on the N-th layer; wherein
the M motion vector densifiers generate the M motion vectors for each sub-block on the N-th layer, on a basis of the M motion vectors detected by the motion estimator.

12. The motion vector detection device of claim 1, wherein the motion estimator receives a pair of temporally distinct frames in the series of frames as input, divides one of the pair of frames into the plurality of blocks, and detects the one or more motion vectors for the block of interest by estimating the motion of each one of the blocks between the pair of frames.

13. The motion vector detection device of claim 1, wherein the motion estimator receives at least three temporally consecutive frames from the series of frames as input, divides an intermediate frame among the at least three frames into the plurality of blocks, and detects the one or more motion vectors for the block of interest by estimating the motion, in the at least three frames, of said each of the blocks.

14. The motion vector detection device of claim 1, wherein the motion vectors for the sub-blocks on the N-th layer have a precision of one pixel.

15. A frame interpolation device comprising:
the motion vector detection device of claim 1; and
an interpolator for generating an interpolated frame on a basis of the motion vectors detected by the motion vector detection device for each of the plurality of sub-blocks on the N-th layer.

16. A motion vector detection method for detecting motion in a series of frames constituting a moving image, comprising:
a motion estimation step of dividing a frame of interest in the series of frames into a plurality of blocks, taking a frame temporally differing from the frame of interest in the series of frames as a reference frame and taking each of the blocks as a block of interest, searching for a reference block being most highly correlated with the block of interest in the reference frame, and detecting a displacement in a spatial direction between the block of interest and the reference block, thereby detecting one or more motion vectors for the block of interest; and
a motion vector densifying step of, using the plurality of blocks as a plurality of sub-blocks on a zeroth layer, hierarchically dividing each of the sub-blocks on the zeroth layer to thereby generate a plurality of sub-blocks on a plurality of layers including a first layer to an N-th layer (N being an integer equal to or greater than 2) and generating a motion vector for each one of the sub-blocks in each layer from the first to the N-th layer; wherein
the motion vector densifying step includes:
a motion vector generation step having the steps of generating a plurality of sub-blocks on each layer from the first layer to the N-th layer based on parent sub-blocks, the parent sub-blocks being the sub-blocks on a higher layer which is at one level higher than said each layer; taking each sub-block in the plurality of sub-blocks as a sub-block of interest, placing in a candidate vector set the motion vector for the corresponding parent sub-block from which the sub-block of interest is generated, and placing in the candidate vector set the motion vector for the sub-block which is on a same layer of the corresponding parent sub-block and located in an area surrounding the corresponding parent sub-block; and selecting a motion vector for the sub-block of interest from the candidate vector set; and
a correction step of, on at least one layer to be corrected among the first to the N-th layers, taking each of the plurality of sub-blocks on the layer to be corrected as a sub-block to be corrected, and correcting the motion vector of the sub-block to be corrected, based on the motion vectors of neighboring sub-blocks located in an area surrounding the sub-block to be corrected the correction step having the step of selecting, from among the motion vectors composed of the motion vector of the sub-block to be corrected and the motion vectors of the neighboring sub-blocks, a correction candidate vector that minimizes a sum of distances between the motion vector of the sub-block to be corrected and the motion vectors of the neighboring sub-blocks, and replacing the motion vector of the sub-block to be corrected with the selected correction candidate vector, thereby correcting the motion vector of the sub-block to be corrected.

17. The motion vector detection method of claim 16, wherein the motion vector generation step includes the step of using the motion vectors as corrected by the motion vector corrector to generate the motion vector of each of the sub-blocks on a lower layer which is at one level lower than the layer to be corrected.

18. (canceled)

19. (canceled)

20. (canceled)

21. The motion vector detection method of claim 16, wherein the motion vector generation step includes the step of selecting a plurality of motion vectors ranking highest in order of reliability from the candidate vector set as motion vectors for the sub-block of interest.

22. The motion vector detection method of claim 16, wherein the plurality of sub-blocks on each layer from the first layer to the N-th layer are generated by subdivision of each of the plurality of sub-blocks on the layer which is at one level higher than said each layer.

23. The motion vector detection method of claim 16, wherein the motion estimation step includes the step of, on a basis of results of estimating the motion of each of the blocks, detecting M motion vectors ranking highest in order of reliability as the motion vectors for the block of interest (M being an integer equal to or greater than 2).

24. The motion vector detection method of claim 23, wherein further comprising the steps of selecting a motion vector of highest reliability from among the M motion vectors for each sub-block.

25. The motion vector detection method of claim 16, wherein the motion estimation step includes the steps of:
receiving a pair of temporally distinct frames in the series of frames as input;
dividing one of the pair of frames into the plurality of blocks; and
detecting the one or more motion vectors for the block of interest by estimating the motion of each one of the blocks between the pair of frames.

26. The motion vector detection method of claim 16, wherein the motion estimation step includes the steps of:
receiving at least three temporally consecutive frames from the series of frames as input;
dividing an intermediate frame among the at least three frames into the plurality of blocks; and
detecting the one or more motion vectors for the block of interest by estimating the motion, in the at least three frames, of said each of the blocks.

27. The motion vector detection method of claim 16, wherein the motion vectors for the sub-blocks on the N-th layer have a precision of one pixel.
